(19) United States
(12) Patent Application Publication
(10) Pub. No.: US 2011/0085027 A1
(43) Pub. Date: Apr. 14, 2011

(54) IMAGE PROCESSING DEVICE AND METHOD, AND PROGRAM

(76) Inventors: Noriyuki YAMASHITA, Tokyo (JP); Jun Hirai, Tokyo (JP)

(21) Appl. No.: 12/880,247

(22) Filed: Sep. 13, 2010

(30) Foreign Application Priority Data
Oct. 9, 2009 (JP) P2009-235405

(51) Int. Cl. H04N 13/02

(52) U.S. Cl. 348/49; 348/E13.074

(57) ABSTRACT

An image processing device includes an output image creation unit configured to create a plurality of consecutive output images; a detection unit configured to detect a moving subject having motion; a correction unit configured to correct a predetermined output image by substituting a subject area, where the moving subject of the predetermined output image is displayed, with an image of an area corresponding to the subject area of another different output image when the moving subject is included in the predetermined output image; and a 3D output image creation unit configured to create a 3D output image including the output image having a predetermined disparity from the predetermined output image.

### BACKGROUND OF THE INVENTION

1. Field of the Invention

The present invention relates to an image processing device and method, and a program, and particularly, to an image processing device and method, and a program capable of obtaining a more natural 3-dimensional image without an uncomfortable feeling.

2. Description of the Related Art

Recently, as digital still cameras are widely popularized, the number of users who enjoy photography increases. In addition, it is desired to provide a method of effectively presenting a number of captured photographs.

For example, as a method of effectively presenting the captured photographs, a so-called panorama image is used in the related art. The panorama image is a single still image obtained by arranging side by side a plurality of still images captured while panning the image capturing device in a predetermined direction such that the same subjects on those still images are overlapped (e.g., refer to Japanese Patent No. 3168443).

In such a panorama image, the subject can be displayed in a space having a wider range than the image capturing range (an angle of view) of the single still image obtained by a typical image capturing device. Therefore, it is possible to more effectively display the captured image of the subject.

The same subjects may be commonly included in several still images when a plurality of still images are captured while panning the image capturing device in order to obtain the panorama image. In such a case, since the same subjects on different still images are captured in different positions, a disparity occurs. If two images having a disparity from each other (hereinafter, referred to as a 3D image) are created from a plurality of the still images based on the aforementioned fact, it is possible to display the capturing target subject in three dimensions by simultaneously displaying such images using a lenticular method.

However, since the images in each area of two images included in the 3D image have a different capturing time point, the same subjects may not be displayed in the same area of the two images in the case where a subject having motion (hereinafter, referred to a moving subject) is included in the capturing target area.

For example, it may be possible that the same moving subject is displayed in different positions on two images included in the 3D image. In such as case, if the two images are simultaneously displayed using a lenticular method, an unnatural image having an uncomfortable feeling may be displayed in the area near the moving subject.

### SUMMARY OF THE INVENTION

It is desirable to obtain a more natural 3D image without an uncomfortable feeling.

According to a first embodiment of the present invention, there is provided An image processing device including: an output image creation means configured to create a plurality of consecutive output images where a particular area as an image capturing target is displayed during image capture of images to be captured based on a plurality of captured images obtained through the image capturing in an image capturing means while moving the image-capturing means; a detection means configured to detect a moving subject having motion from the output images based on motion estimation using the output images; a correction means configured to correct a predetermined output image to remove the moving subject included in the predetermined output image based on a result of detection of the moving subject by substituting a subject area, where the moving subject of the predetermined output image is displayed, with an image of an area corresponding to the subject area of another different output image when the moving subject is included in the predetermined output image; and a 3D output image creation means configured to create a 3D output image including the output image having a predetermined disparity from the predetermined output image out of a plurality of the output images and the corrected predetermined output image.

The output image creation means may cut out an area, where the particular area is displayed, from a plurality of the captured images and create a plurality of the output images.

The correction means may correct the output image by substituting the subject area of the output image with an image of an area, where the moving subject of another different output image is not displayed, corresponding to the subject area when the output images include the moving subject for each of a plurality of the output images, and the 3D output image creation means may create a 3D output image group including a first output image group having the output images obtained from a plurality of consecutively captured images and a second output image group having the output images obtained from a plurality of the consecutively captured images and having a disparity from the first output image group out of a plurality of the output images including the corrected output image.

The correction means may correct the first output image by substituting the subject area of the first output image with an image of an area of the second output image corresponding to the subject area when the moving subject is included in the first output image, and the moving subject is included in an area corresponding to the subject area of the first output image in the second output image as the output image having a disparity from the first output image out of a plurality of the output images, for the first output image group having the first output images as the output images obtained from several consecutively captured images, and the 3D output image creation means may create the 3D output image group including the corrected first output image group and a second output image group having each of the second output images having a disparity from each of the first output images included in the first output image group.

According to a first embodiment of the present invention, there is provided an image processing method or program including the steps of: creating a plurality of consecutive output images where a particular area as an image capturing target is displayed during capture of images to be captured based on a plurality of captured images obtained through the image capturing using an image capturing means while moving the image-capturing means, detecting a moving subject having motion from the output images based on motion estimation using the output images, correcting a predetermined output image to remove the moving subject included in the predetermined output image based on a result of detection of the moving subject by substituting a subject area, where the moving subject of the predetermined output image is displayed, with an image of an area corresponding to the subject area of another different output image when the moving subject is included in the predetermined output image, and creating a 3D output image including the output image having a predetermined disparity from the predetermined output image out of a plurality of the output images and the corrected predetermined output image.

In the first embodiment of the present invention, a plurality of consecutive output images where a particular area as an image capturing target is displayed during capture of images to be captured are created based on a plurality of captured images obtained through the image capturing using an image capturing means while moving the image-capturing means. A moving subject having motion is detected from the output images based on motion estimation using the output images. A predetermined output image is corrected to remove the moving subject included in the predetermined output image based on a result of detection of the moving subject by substituting a subject area, where the moving subject of the predetermined output image is displayed, with an image of an area corresponding to the subject area of another different output image when the moving subject is included in the predetermined output image. A 3D output image including the output image having a predetermined disparity from the predetermined output image out of a plurality of the output images and the corrected predetermined output image is created.

According to a second embodiment of the present invention, there is provided an image processing device including: a strip image creation means configured to create a first strip image by cutting a predetermined area on the captured image for each of a plurality of captured images obtained using an image capturing means while moving the image capturing means and create a second strip image by cutting an area different from the predetermined area on the captured image; a panorama image creation means configured to create a 3D panorama image including first and second panorama images having a disparity from each other by collectively synthesizing each of the first and second strip images obtained from a plurality of the captured images and displaying the same area on an image capturing space used as an image capturing target during capture of a plurality of the images to be captured; a detection means configured to detect a moving subject having motion from the captured images based on motion estimation using the captured images; and a correction means configured to correct the first panorama image to remove the moving subject included in the first panorama image based on a result of detection of the moving subject by substituting a subject area included in the moving subject on the first panorama image with an image of an area corresponding to the subject area on the captured image when the moving subject is included in the first panorama image.

The correction means may correct the first panorama image by substituting the subject area on the first panorama image with an image of an area corresponding to the subject area, where the moving subject on the captured image is not displayed, when the moving subject is included in the first panorama image, and the correction means may correct the second panorama image by substituting the subject area on the second panorama image with an image of an area corresponding to the subject area, where the moving subject on the captured image is not displayed, when the moving subject is included in the second panorama image.

When the moving subject is included in the first panorama image, the correction means may correct the first panorama image by substituting the subject area on the first panorama image with an image of an area corresponding to the subject area, where the moving subject on the captured image is displayed, and the correction means corrects the second panorama image by substituting an area of the second panorama image corresponding to the subject area with an image of an area corresponding to the subject area, where the moving subject on the captured image is displayed.

According to a second embodiment of the present invention, there is provided an image processing method or program including the steps of: creating a first strip image by cutting a predetermined area on a captured image for each of a plurality of captured images obtained using an image capturing means while moving the image capturing means and a second strip image by cutting an area different from the predetermined area on the captured image; creating a 3D panorama image including first and second panorama images having a disparity from each other by collectively synthesizing each of the first and second strip images obtained from a plurality of the captured images and displaying the same area on an image capturing space used as an image capturing target during capture of a plurality of the images to be captured; detecting a moving subject having motion from the captured images based on motion estimation using the captured images; and correcting the first panorama image to remove the moving subject included in the first panorama image based on a result of detection of the moving subject by substituting a subject area included in the moving subject on the first panorama image with an image of an area corresponding to the subject area on the captured image when the moving subject is included in the first panorama image.

In the second embodiment of the present invention, a first strip image is created by cutting out a predetermined area on a captured image for each of a plurality of captured images obtained using an image capturing means while moving the image capturing means and a second strip image by cutting an area different from the predetermined area on the captured image. At the same time, a 3D panorama image including first and second panorama images having a disparity from each other is created by collectively synthesizing each of the first and second strip images obtained from a plurality of the captured images and displaying the same area on an image capturing space used as an image capturing target during capture of a plurality of images to be captured. A moving subject having motion is detected from the captured images based on motion estimation using the captured images. The first panorama image is corrected to remove the moving subject included in the first panorama image based on a result of detection of the moving subject by substituting a subject area included in the moving subject on the first panorama image with an image of an area corresponding to the subject area on the captured image when the moving subject is included in the first panorama image.

According to a first embodiment of the present invention, it is possible to obtain a more natural 3D image without an uncomfortable feeling.

According to a second embodiment of the present invention, it is possible to obtain a more natural 3D image without an uncomfortable feeling.

### BRIEF DESCRIPTION OF THE DRAWINGS

FIG. 1 illustrates a method of capturing captured images.

FIG. 2 illustrates a disparity generated during the image capturing;

FIG. 3 illustrates a display example of the 3D panorama moving picture;

FIG. 4 illustrates an exemplary configuration of the image capturing device according to an embodiment of the present invention;

FIG. 5 illustrates an exemplary configuration of the signal processing unit;

FIG. 6 is a flowchart illustrating a process of reproducing a moving picture;

FIG. 7 illustrates position matching of the captured images;

FIG. 8 illustrates calculation of the coordinates of the center;

FIG. 9 is a flowchart illustrating a process of reproducing the 3D panorama moving picture;

FIG. 10 illustrates truncation of the strip image;

FIG. 11 illustrates creation of the 3D panorama moving picture;

FIG. 12 is a flowchart illustrating a process of reproducing the 3D partial moving picture;

FIG. 13 illustrates creation of the 3D partial moving picture;

FIG. 14 is a flowchart illustrating a process of displaying the 3D panorama image; and

FIG. 15 illustrates an exemplary configuration of a computer.

### DESCRIPTION OF THE PREFERRED EMBODIMENTS

Hereinafter, embodiments of the present invention will be described in more detail with reference to the accompanying drawings.

Description of 3D Panorama Moving Picture

The image capturing device according to the present invention includes, for example, a camera or the like and creates a single 3D panorama moving picture from a plurality of captured images continuously captured by the image capturing device while the image capturing device moves. The 3D panorama moving picture includes two panorama moving pictures having a disparity.

The panorama moving picture is an image group including a plurality of panorama images by which an area having a wider range than the angle of view in real space that can be captured by the image capturing device through a single try of the image capturing displayed as a subject. Therefore, assuming that each panorama image included in the panorama moving picture is an image corresponding to a single frame, the panorama moving picture may be a single moving picture. Similarly, assuming that each panorama image included in the panorama moving picture is a single still image, the panorama moving picture may be a group of still images. Hereinafter, for a purpose of convenience, it is assumed that the panorama moving picture is a moving picture.

When a user tries to create a 3D panorama moving picture using the image capturing device, a user manipulates the image capturing device to capture the captured images used to create the 3D panorama moving picture.

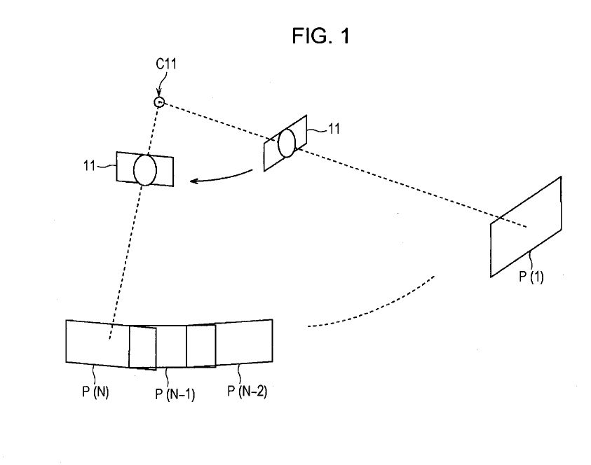

For example, as shown in FIG. 1, in order to capture the captured images, a user continuously captures images of the subject by directing an optical lens of the image capturing device 11 toward the front side of the drawing and pivoting (panning) the image capturing device 11 from the right side to the left side in the drawing with respect to the pivot center C11. At this moment, a user adjusts the pivot speed of the image capturing device 11 such that the quiescent subject can be included in a plurality of captured images continuously captured.

In this manner, it is possible to obtain N captured images P(1) to P(N) by capturing captured images while the image capturing device 11 moves.

Here, the captured image P(1) is the image having the earliest shot time out of N captured images, that is, the first captured image. The captured image P(N) is the image having the latest shot time out of N captured images, that is, the last captured image. Hereinafter, the (n)th captured image (where, 1≦n≦N) is referred to as a captured image P(n).

In addition, each captured image may be one of continuously-shot still images or an image corresponding to a single frame of the moving picture taken.

While, in FIG. 1, the images are taken by rotating the image capturing device 11 itself by 90°, i.e., horizontally positioning the image capturing device 11, the captured image may be captured by horizontally positioning the image capturing device 11 when it is possible to obtain the captured image elongated in a vertical direction in the drawing. In this case, the captured image is rotated by 90° in the same direction as that of the image capturing device 11 to create the panorama moving picture.

When N captured images are obtained in this way, the image capturing device 11 creates two panorama moving pictures having a disparity with each other using such captured images. Here, in the panorama moving pictures, the entire area of the image capturing space targeted to the image capturing when N captured images are captured is displayed as a subject.

Two panorama moving pictures having a disparity can be obtained from the captured images because a plurality of captured images are captured while the image capturing device 11 moves, and the subject on the captured images has a disparity.

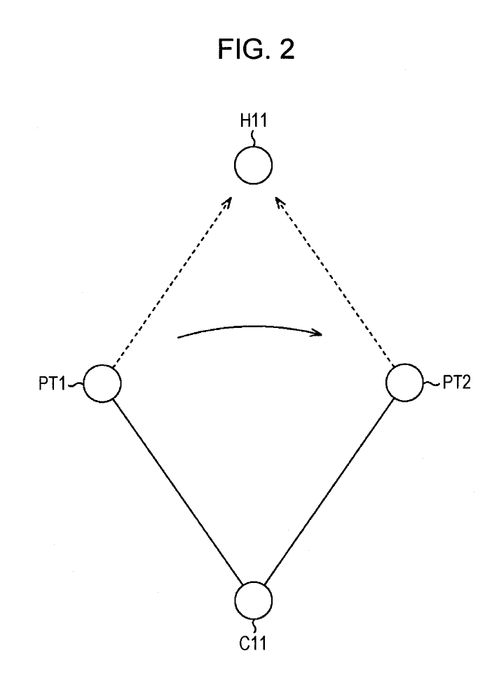

For example, as shown in FIG. 2, the captured images are captured in the positions PT1 and PT2 when the captured images are captured by pivoting the image capturing device 11 in the arrow direction in the drawing with respect to the pivot center C11.

In this case, while the same subject H11 is included in the captured images captured when the image capturing device 11 is located in each of the positions PT1 and PT2, those captured images are different in the image capturing position, i.e., an observation position of the subject H11. As a result, a disparity occurs. When the image capturing device 11 is pivoted at a constant pivot speed, the disparity increases as distance from the pivot center C11 to the image capturing device 11 increases, for example, as the distance from the pivot center C11 to the position PT1 increases.

Based on the disparity occurring in this manner, a user can be provided with a 3D panorama moving picture if two panorama moving pictures are created at different observation positions (i.e., a disparity occurs), and the panorama moving pictures are simultaneously reproduced using a lenticular method or the like.

Hereinafter, out of two panorama moving pictures of the 3D panorama moving picture, the panorama moving picture displayed to be observed by the right eye of a user is referred to as a right eye panorama moving picture. Similarly, out of two panorama moving pictures of the 3D panorama moving picture, the panorama moving picture displayed to be observed by the left eye of a user is referred to as a left eye panorama moving picture.

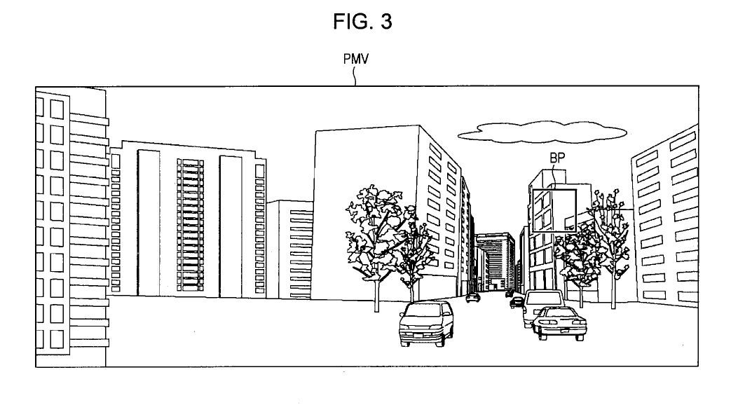

As the 3D panorama moving picture is created, the 3D panorama moving picture PMV shown in FIG. 3 is displayed, for example, on the image capturing device 11. If a user instructs to display another image relating to the 3D panorama moving picture PMV while the 3D panorama moving picture PMV is displayed, the image corresponding to the instruction can be further displayed.

For example, as a user specifies a magnification and an arbitrary position on the 3D panorama moving picture PMV, the image capturing device 11 displays a 3D partial moving picture, in which only an area BP on the 3D panorama moving picture PMV determined by the specified magnification is used as a subject, with respect to the specified position. That is, the process of displaying the 3D partial moving picture is a process of magnifying and displaying a partial area of the 3D panorama moving picture.

In addition, a 3D panorama image is displayed on the image capturing device 11 in response to the user's instruction. The 3D panorama image is a still image where the same area as that of the image capturing space displayed on the 3D panorama moving picture PMV is displayed. That is, the 3D panorama image is an image pair including right eye and left eye panorama images included in a single frame of the 3D panorama moving picture PMV.

Configuration of Image Capturing Device

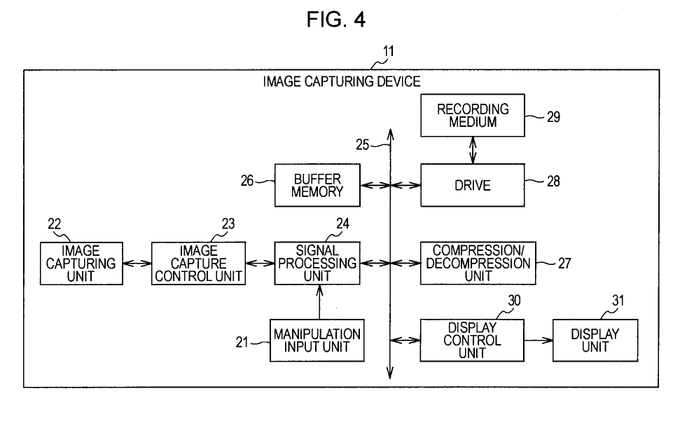

FIG. 4 illustrates an exemplary configuration of the image capturing device 11 according to an embodiment of the present invention.

The image capturing device 11 includes a manipulation input unit 21, an image capturing unit 22, an image capturing control unit 23, a signal processing unit 24, a bus 25, a buffer memory 26, a compression/decompression unit 27, a drive 28, a recording medium 29, a display control unit 30, and a display unit 31.

The manipulation input unit 21 includes a button or the like to receive a user's manipulation and supply a signal corresponding to the manipulation to the signal processing unit 24. The image capturing unit 22 includes an optical lens, an image capturing element, or the like to capture the captured image by optoelectrically converting the light from the subject and supply it to the image capturing control unit 23. The image capturing control unit 23 performs control for the image capture of the image capturing unit 22 and supplies the captured image obtained from the image capturing unit 22 to the signal processing unit 24.

The signal processing unit 24 is connected to the buffer memory 26 to the drive 28, and the display control unit 30 through the bus 25 so as to perform control for the entire image capturing device 11 in response to the signal from the manipulation input unit 21.

For example, the signal processing unit 24 supplies the captured image from the image capturing control unit 23 to the buffer memory 26 through the bus 25 or creates the 3D panorama moving picture based on the captured image obtained from the buffer memory 26. In addition, the signal processing unit 24 also creates the 3D partial moving picture based on the captured image obtained from the buffer memory 26.

The buffer memory 26 includes a synchronous dynamic random access memory (SDRAM) or the like to temporarily record data such as the captured image supplied through the bus 25. The compression/decompression unit 27 encodes or decodes the image supplied through the bus 25 using a predetermined scheme.

The drive 28 records the 3D panorama moving picture supplied from the bus 25 in the recording medium 29 or reads the 3D panorama moving picture recorded in the recording medium 29 to output it to the bus 25. The recording medium 29 includes a non-volatile memory detachable to the image capturing device 11 to record the 3D panorama moving picture under control of the drive 28.

The display control unit 30 supplies the display unit 31 with the 3D panorama moving picture or the like supplied through the bus 25 to display it. The display unit 31 includes a liquid crystal display (LCD) or a lenticular lens to display a 3D image in a lenticular type under control of the display control unit 30.

Configuration of Signal Processing Unit

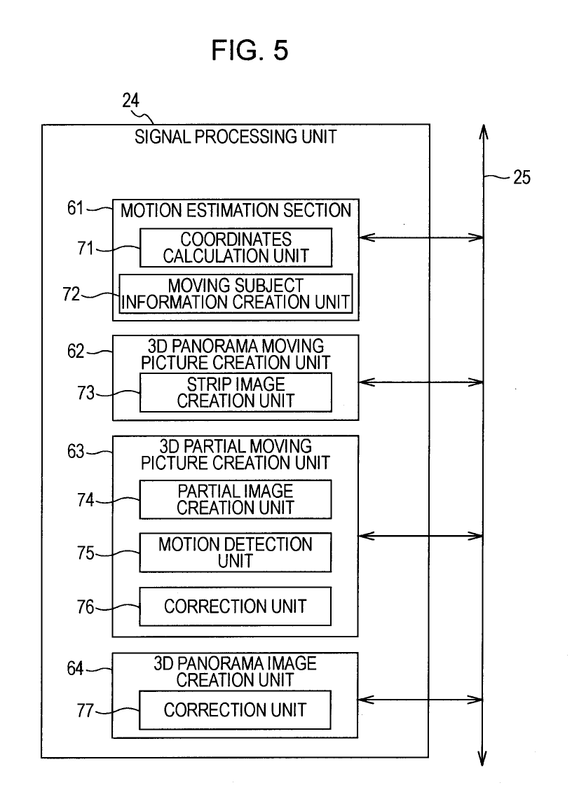

The signal processing unit 24 of FIG. 4 is configured in more detail as shown in FIG. 5.

Specifically, the signal processing unit 24 includes a motion estimation unit 61, a 3D panorama moving picture creation unit 62, a 3D partial moving picture creation unit 63, and a 3D panorama image creation unit 64.

The motion estimation unit 61 performs motion estimation using two captured images that are supplied through the bus 25 and have different shot times. The motion estimation unit 61 includes a coordinate calculation unit 71 and a moving subject information creation unit 72.

The coordinate calculation unit 71 creates information representing a relative positional relationship between captured images when the captured images are arranged side by side on a predetermined plane such that two captured images of the same subjects can be overlapped based on the result of the motion estimation. Specifically, coordinates of the center position of the captured image (hereinafter, referred to as a center coordinates) obtained when a 2D x-y coordinate system is set on a predetermined plane are calculated as information representing the relative positional relationship of the captured image.

The moving subject information creation unit 72 detects a subject having motion from the captured images by obtaining a difference between overlapping portions of the captured images when two captured images are arranged side by side on a plane based on the center coordinates and creates moving subject information representing the detection result. Hereinafter, the subject moving on the images such as the captured image is referred to as a moving object.

The 3D panorama moving picture creation unit 62 creates the 3D panorama moving picture including right eye and left eye panorama moving pictures using the center coordinates and the captured images supplied through the bus 25. The 3D panorama moving picture creation unit 62 has a strip image creation unit 73.

The strip image creation unit 73 cuts a predetermined area on the captured image using the center coordinates and the captured image, and creates right eye and left eye strip images. The 3D panorama moving picture creation unit 62 synthesizes the created right eye and left eye strip images to create right eye and left eye panorama images. In addition, the 3D panorama moving picture creation unit 62 creates right eye and left eye panorama moving pictures as a panorama image group by creating a plurality of right eye and left eye panorama images.

Here, a panorama moving picture corresponding to a single frame, i.e., a single panorama image is an image where the entire range (area) of the image capturing space functioning as an image capturing target when the captured image is captured is displayed as a subject.

The 3D partial moving picture creation unit 63 creates the 3D partial moving picture using the center coordinates and the captured image supplied through the bus 25. The 3D partial moving picture includes a plurality of partial images that are images where only a predetermined area on the 3D panorama moving picture is displayed.

In addition, the 3D partial moving picture creation unit 63 includes a partial image creation unit 74, a motion detection unit 75, and a correction unit 76. The partial image creation unit 74 specifies a captured image where a predetermined area on the 3D panorama moving picture is displayed out of a plurality of captured images and cuts the area where a predetermined area is displayed from the specified captured image to create a partial image.

The motion detection unit 75 detects the moving subject from the partial image through the motion estimation using the created partial image. The correction unit 76 corrects the partial image based on the detection result of the motion from the motion detection unit 75 and removes (erases) the moving subject from the partial image or allows the same moving subject to be displayed in the same position of the right eye and left eye partial images of the same frame.

The 3D partial moving picture creation unit 63 creates right eye and left eye partial moving pictures that constitute a partial image group by setting partial images of several corrected successive frames as the right eye partial moving picture and setting partial images of several corrected successive frames as a left eye partial moving picture. Such right eye and left eye partial moving pictures constitute a single 3D partial moving picture.

The 3D panorama image creation unit 64 sets a pair of right eye and left eye panorama images corresponding to a single frame of the 3D panorama moving picture obtained by the signal processing unit 24 as the 3D panorama image. The 3D panorama image creation unit 64 includes a correction unit 77.

The correction unit 77 corrects the right eye and left eye panorama images based on the captured images, the center coordinates, and the moving subject information supplied through the bus 25 to erase the moving subject from the panorama images or display the same moving subject in the same position of the right eye and left eye panorama images. The right eye and left eye panorama images corrected by the correction unit 77 are used as final 3D panorama images.

Description of Process of Reproducing Moving Picture

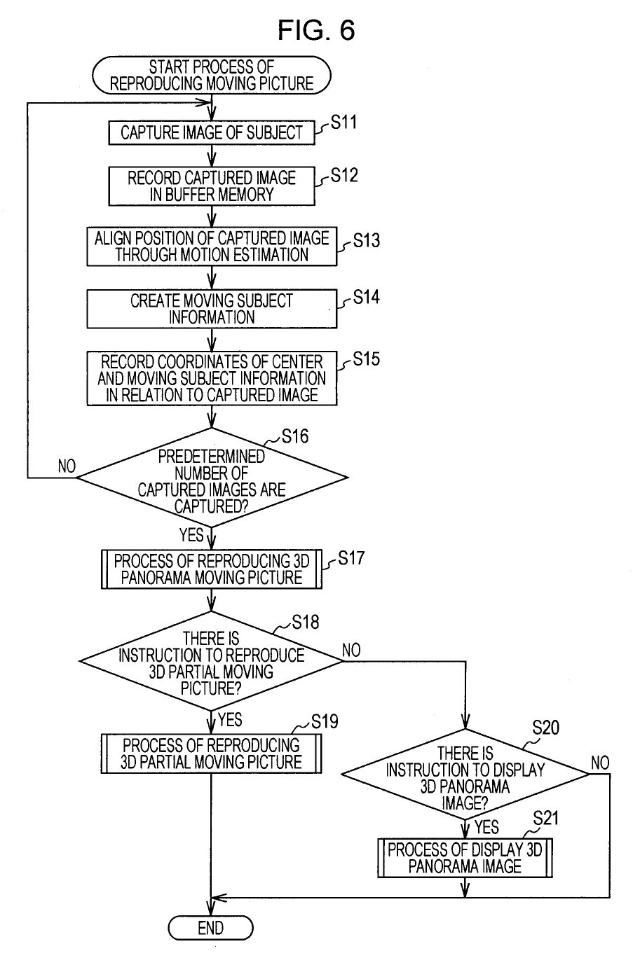

Next, a process of producing the moving picture in which the image capturing device 11 captures images and creates various moving pictures such as the 3D panorama moving picture to reproduce those moving pictures will be described with reference to the flowchart of FIG. 6. The process of reproducing the moving picture is initiated when a user manipulates the manipulation input unit 21 to instruct creation of the 3D panorama moving picture.

In step S11, the image capturing unit 22 captures images of the subject while the image capturing device 11 moves as shown in FIG. 1. As a result, a single captured image (hereinafter, referred to as a single frame) can be obtained. The image captured by the image capturing unit 22 is supplied from the image capturing unit 22 to the signal processing unit 24 through the image capturing control unit 23.

In step S12, the signal processing unit 24 supplies the buffer memory 26 with the captured image supplied from the image capturing unit 22 through the bus 25 to temporarily record it. In this case, the signal processing unit 24 performs recording by allocating a frame number to the captured image in order to specify what number the recorded images are captured. In addition, hereinafter, the (n)th captured image P(n) is referred to as a captured image P(n) of a frame n.

In step S13, the motion estimation unit 61 obtains the captured images of the current frame n and the immediately previous frame (n−1) from the buffer memory 26 via the bus 25 and performs position matching of the captured images based on the motion estimation.

For example, if, in the immediately previous step S12, the captured image recorded in the buffer memory 26 is the captured image P(n) captured in the (n)th time, the motion estimation unit 61 obtains the captured image P(n) of the current frame n and the captured image P(n−1) of the immediately previous frame (n−1).

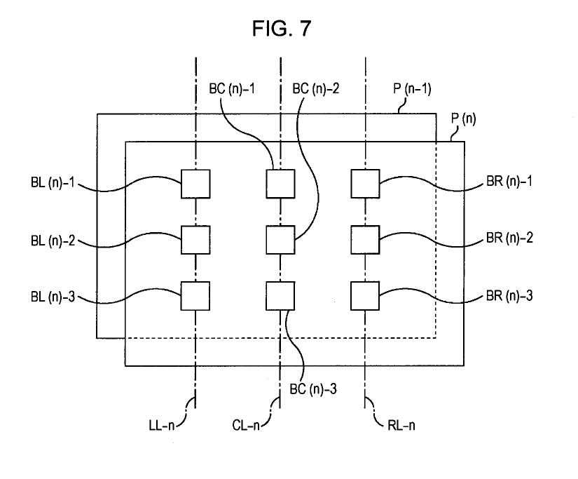

Then, as shown in FIG. 7, the motion estimation unit 61 performs position matching by searching where the same image as 9 blocks BL(n)-1 to BR(n)-3 in the captured image P(n) is located in the captured image P(n−1) of the immediately previous frame.

Here, the blocks BC(n)-1 to BC(n)-3 are included in a rectangular area arranged side by side in the vertical direction in the drawing on the boundary CL-n as a virtual vertical straight line in the drawing located near the center of the captured image P(n).

In addition, the blocks BL(n)-1 to BL(n)-3 are included in a rectangular area arranged side by side in the vertical direction in the drawing on the boundary LL-n as a virtual vertical straight line located in the left side of the boundary CL-n in the drawing. Similarly, the blocks BR(n)-1 to BR(n)-3 are included in a rectangular area arranged side by side in the vertical direction in the drawing on the boundary RL-n as a virtual vertical straight line located in the right side of the boundary CL-n in the drawing of the captured image P(n). Locations of 9 blocks BL(n)-1 to BR(n)-3 are determined in advance.

For each of 9 blocks on the captured image P(n), the motion estimation unit 61 searches an area (hereinafter, referred to as a block matching area) having a smallest difference between blocks in the area of the captured image P(n−1) having the same shape and size as that block. Here, the difference between blocks is set to a sum of absolute difference values of pixel values of pixels located in the same position between a processing target block, for example, the block BL(n)-1 and the area corresponding to a candidate of the block matching area, or the like.

When such motion estimation is performed, for each of the blocks BL(n)-1 to BR(n)-3 in the captured image P(n), it is possible to obtain a block matching area located in the captured image P(n−1) with a positional relationship equal to a relative positional relationship of those blocks.

A block matching area of the captured image P(n−1) corresponding to a processing target block in the captured image P(n) is an area having a smallest difference from the processing target block in the captured image P(n−1). For this reason, it is estimated that the same image as that of the processing target block is displayed in the block matching area.

Therefore, if the captured image P(n) and the captured image P(n−1) are overlappingly arranged on a predetermined plane such that the blocks BL(n)-1 to BR(n)-3 and corresponding the block matching areas are overlapped, the same subjects in those captured images may be overlapped.

However, in practice, the block and the block matching area may not have the same position relationship. Therefore, more specifically, the motion estimation unit 61 arranges the captured image P(n) and the captured image P(n−1) on a plane such that all of the blocks and the block matching areas are nearly overlapped, and the result thereof is used as a result of the position matching of the captured images.

In addition, when a subject having motion exists in the captured image, and the subject is included in the block in the captured image P(n), the obtained 9 block matching areas do not have the same positional relationship with the blocks BL(n)-1 to BR(n)-3.

In this regard, the motion estimation unit 61 performs positional matching based on the motion estimation again by excluding the blocks estimated to include the subject having motion when a relative positional relationship of the obtained block matching areas is different from a relative positional relationship of the blocks in the captured image P(n). In other words, a block matching area having a different relative positional relationship from other block matching areas is detected, and the motions estimation is performed again using remaining blocks by excluding the blocks in the captured image P(n) corresponding to the detected block matching area from the processing target.

Specifically, it is assumed that the blocks BL(n)-1 to BR(n)-3 are arranged side by side in a matrix shape with the same interval of a distance QL in FIG. 7. For example, both of a distance between neighboring blocks BL(n)-1 and BL(n)-2 and a distance between blocks BL(n)-1 and BC(n)-1 are set to QL. In this case, the motion estimation unit 61 detects a block having motion in the captured image P(n) based on a relative positional relationship of the block matching areas corresponding to each block.

That is, the motion estimation unit 61 obtains a distance QM between neighboring block matching areas, for example, between the block matching area corresponding to the block BR(n)-3 and the block matching area corresponding to the block BC(n)-3.

As a result, for the blocks BR(n)-2 and BC(n)-3, the absolute value of a difference between the distance QL and the distance QM between the block matching areas corresponding to those blocks and the block matching area corresponding to the block BR(n)-3 is equal to or larger than a predetermined threshold value.

In addition, the absolute value of a difference between a distance QL and a distance QM between the block matching areas corresponding to the blocks BR(n)-2 and BC(n)-3 and other neighboring block matching areas (excluding the block matching area of the block BR(n)-3) is smaller than a predetermined threshold value.

In this case, the block matching areas of other blocks different from the block BR(n)-3 are arranged side by side with the same positional relationship as the relative positional relationship of each block. However, only the block matching area of the block BR(n)-3 has a different positional relationship from the positional relationship of each block with respect to other block matching areas. In the case where such a detection result is obtained, the motion estimation unit 61 determines that a subject having motion is included in the block BR(n)-3.

In addition, in order to detect a block having motion, a rotation angle with respect to another neighboring block matching area of the targeted block matching area as well as a distance between neighboring block matching areas may be used. That is, for example, if there is a block matching area inclined to a predetermined angle or more with respect to other block matching areas, it is considered that there is a subject having motion in the block corresponding to the block matching area.

In this manner, as a block having motion is detected, the motion estimation unit 61 performs position matching between the captured images P(n) and P(n−1) again based on the motion estimation using remaining blocks excluding the block having motion.

In this manner, it is possible to more accurately perform position matching by performing position matching using only the blocks included in a subject having no motion excluding the block including the subject having motion, i.e., included in a background. If the captured images P(n) and P(n−1) are arranged side by side based on the result of the position matching, it is possible to overlappingly arrange those captured images such that the subject having no motion can be overlapped.

After the position matching is performed, the coordinate calculation unit 71 calculates center coordinates of the captured image P(n) when the images P(1) to P(n) captured until now are arranged side by side on a predetermined plane, i.e., an x-y coordinate system based on the result of the position matching for each frame.

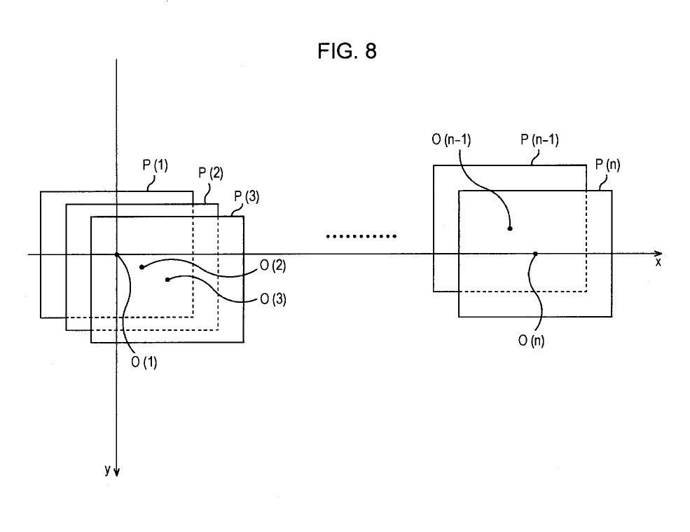

For example, as shown in FIG. 8, each of the captured images is arranged such that the center of the captured image P(1) is located in the origin of the x-y coordinate system, and the subjects included in the captured images are overlapped. In addition, in the drawing, the horizontal direction denotes the x direction, and the vertical direction denotes the y direction. Furthermore, each of the points O(1) to O(n) in the captured images P(1) to P(n) denotes the position of the center of the captured image.

For example, if the captured image of the current processing target frame is the captured image P(n), the center coordinates of the points O(1) to O(n−1) of each center of the captured images P(1) to P(n−1) are already obtained and recorded in the buffer memory 26.

The coordinate calculation unit 71 reads the center coordinates of the captured image P(n−1) from the buffer memory 26 and obtains the center coordinates of the captured image P(n) based on the result of position matching between the captured images P(n) and P(n−1) and the read center coordinates. That is, the x coordinate and the y coordinate of the point O(n) is obtained as the center coordinates.

Returning to the description of the flowchart of FIG. 6, in step S13, as the center coordinates of the captured image P(n) is obtained through the position matching, the process advances to step S14.

In step S14, the moving subject information creation unit 72 detects the moving subject from the overlapping portion of the captured images when the captured images P(n) and P(n−1) of the current frame are arranged in the x-y coordinate system based on the center coordinates and creates the moving subject information.

Specifically, the moving subject information creation unit 72 arranges the captured images in the x-y coordinate system base on the center coordinates of the captured images P(n) and P(n−1). Then, the moving subject information creation unit 72 detects the moving subject by obtaining a difference of pixel values of the pixels of each area for a portion where the captured images P(n) and P(n−1) are overlapped with reference to the moving subject information recorded in the buffer memory 26 as necessary.

As the captured images P(n) and P(n−1) are overlappingly arranged, the subject having no motion will be overlapped. In this regard, when an area having a size equal to or larger than a predetermined size and including pixels in which the absolute value of the difference in the pixel values is equal to or larger than a predetermined threshold value is detected from the captured image, the moving subject information creation unit 72 sets those areas as an area where the moving subject is displayed.

The moving subject information creation unit 72 detects the moving subject using captured images of two consecutive frames. Therefore, the moving subject information creation unit 72 can recognize from what frame the moving subject appears on the captured image and in what frame the moving subject that has been displayed until now is not displayed in the captured image based on such a detection result and the captured images of each frame. In addition, the moving subject information creation unit 72 can identify an individual moving subject through the block matching or the like based on the detection result of the moving subject and the captured images. That is, it is possible to specify whether or not the moving subjects on each captured image are identical.

The moving subject information creation unit 72 detects the moving subject out of the captured image P(n) and creates the moving subject information representing the detection result thereof. For example, the moving subject information includes information representing whether or not the moving subject exists on the captured image P(n), positional information representing where the moving subject is present on the captured image P(n), and specifying information for specifying each moving subject included in the captured image P(n).

In step S15, the motion estimation unit 61 supplies the buffer memory 26 with the center coordinates of the obtained captured image P(n) and the moving subjection information and records them in relation to the captured images P(n).

In step S16, the signal processing unit 24 determines whether or not a predetermined number of captured images are captured. For example, as shown in FIG. 1, in the case where an area within a predetermined space is divided by N and image capturing is performed N times, it is determined that a predetermined number of captured images are captured when N captured images are captured.

In addition, in the case where the image capturing device 11 is installed with a device such as a gyro-sensor for allowing the image capturing device 11 to detect a pivot angle, whether or not the image capturing device 11 is pivoted by a predetermined angle after the image capturing is initiated may be determined instead of the number of the captured images. Even in this case, it is possible to specify whether or not the capture of the images has been performed by using the entire particular area within a predetermined space as a subject.

In step S16, in the case where it is determined that a predetermined number of captured images have not be captured, the process returns to step S11, and captured image of the next frame are captured.

On the contrary, in step S16, in the case where a predetermined number of captured images have been captured, the process advances to step S17.

In step S17, the image capturing device 11 performs a process of reproducing the 3D panorama moving picture. Specifically, the signal processing unit 24 obtains the center coordinates and the captured images from the buffer memory 26 and creates two panorama moving pictures having a disparity based on the center coordinates and the captured images. In addition, the display control unit 30 reproduces two created panorama moving pictures, i.e., the 3D panorama moving picture and sequentially displays a pair of right eye and left eye panorama images in the display unit 31. In addition, the process of reproducing the 3D panorama moving picture will be described below in more detail.

In step S18, the signal processing unit 24 determines whether or not reproduction of the 3D partial moving picture is instructed based on the signal from the manipulation input unit 21. For example, if a user manipulates the manipulation input unit 21 to specify a predetermined area of the 3D panorama moving picture and a magnification, and reproduction of the 3D partial moving picture is instructed, it is determined that reproduction of the 3D partial moving picture is instructed.

If it is determined that reproduction of the 3D partial moving picture is instructed in step S18, the image capturing device 11 perform a process of reproducing the 3D partial moving picture in step S19 so that the process of reproducing the moving picture is terminated.

That is, the 3D partial moving picture is created, and the created 3D partial moving picture is reproduced based on the captured image recorded in the buffer memory 26 and the center coordinates. In addition, the process of reproducing the 3D partial moving picture will be described in more detail.

On the contrary, in step S18, if it is determined that reproduction of the 3D partial moving picture is not instructed, the process advances to step S20.

In step S20, the signal processing unit 24 determines whether or not display of the panorama image is instructed based on the signal from the manipulation input unit 21.

If it is determined that display of the 3D panorama image is instructed in step S20, the image capturing device 11 performs a process of displaying the 3D panorama image and terminates the process of reproducing the moving picture in step S21. That is, the 3D panorama image is created and displayed based on the 3D panorama moving picture that is being displayed, the captured image recorded in the buffer memory 26, the center coordinates, and the moving subject information. In addition, a process of displaying the 3D panorama image will be described in more detail.

On the contrary, if it is determined that display of the 3D panorama image is not instructed in step S20, the process of reproducing the moving picture is terminated as the reproduction of the 3D panorama moving picture that is being displayed in the display unit 31 is terminated.

In this manner, the image capturing device 11 creates the 3D panorama moving picture using a plurality of images captured in different time points and reproduces it. In addition, as the image capturing device 11 is instructed to reproduce the 3D panorama moving picture or display the 3D panorama image during reproduction of the 3D panorama moving picture, the image capturing device 11 reproduce the 3D partial moving picture or display the 3D panorama image in response to the instruction.

Description of Process of Reproducing 3D Panorama Moving Picture

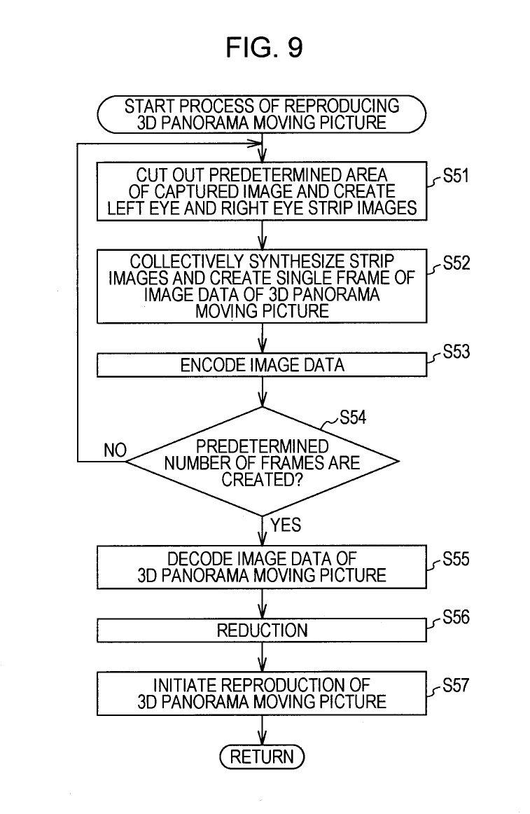

Next, a process of reproducing the 3D panorama moving picture corresponding to the process of step S17 of FIG. 6 will be described with reference to the flowchart of FIG. 9.

In step S51, the strip image creation unit 73 obtains N captured images and center coordinates thereof from the buffer memory 26 and creates the right eye and left eye strip images by cutting a predetermined area of each captured image based on the obtained captured image and the center coordinates.

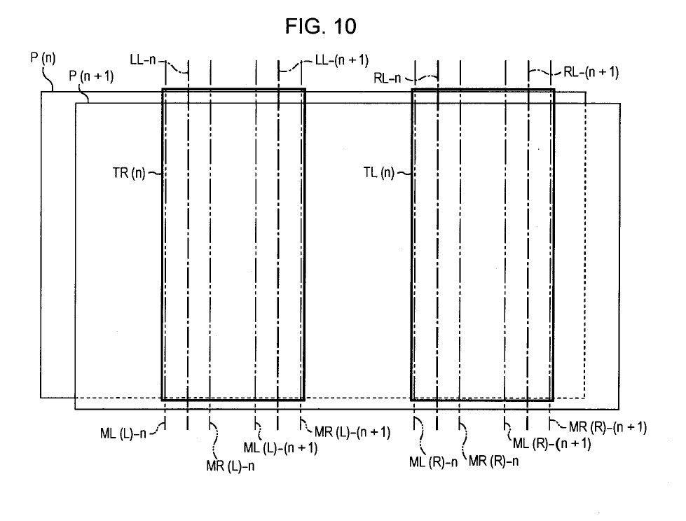

For example, the strip image creation unit 73 sets an area defined by using the boundary LL-n on the captured image P(n) as a reference as the cutout area TR(n) and cuts the cutout area TR(n) to set it as the right eye strip image as shown in FIG. 10. In addition, the strip image creation unit 73 sets an area defined by using the boundary RL-n on the captured image P(n) as a reference as a cutout area TL(n) and cuts the cutout area TL(n) to set it as the left eye strip image. In FIG. 10, like reference numerals denote like elements as in FIG. 7, and descriptions thereof will be omitted.

In FIG. 10, the consecutively captured images P(n) and P(n+1) are arranged side by side such that the same subjects are overlapped based on such center coordinates. The boundary LL-(n+1) of the captured image P(n+1) corresponds to the boundary LL-n of the captured image P(n). In other words, the boundaries LL-n and LL-(n+1) are virtual vertical straight lines in the drawings where the captured images P(n) and P(n+1) are present in the same position.

Similarly, in the drawing, the boundary RL-(n+1) on the captured image P(n+1) which is a vertical straight line corresponds to the boundary RL-n in the captured image P(n).

In addition, in the drawing, the boundaries ML(L)-n and MR(L)-n as vertical straight lines are straight lines located near the boundary LL-n on the captured image P(n) and are located with a predetermined distance in the left and right sides, respectively, of the boundary LL-n.

Similarly, in the drawing, the boundaries ML(L)-(n+1) and MR(L)-(n+1) as vertical straight lines are straight lines located near the boundary LL-(n+1) on the captured image P(n+1) and are located with a predetermined distance in the left and right sides, respectively, of the boundary LL-(n+1).

Furthermore, in the drawing, the boundaries ML(R)-n and MR(R)-n as vertical straight lines are straight lines located near the boundary RL-n on the captured image P(n) and are located with a predetermined distance in the left and right sides, respectively, of the boundary RL-n. Similarly, in the drawing, the boundaries ML(R)-(n+1) and MR(R)-(n+1) as vertical straight lines are straight lines located near the boundary RL-(n+1) on the captured image P(n+1) and are located with a predetermined distance in the left and right sides, respectively, of the boundary RL-(n+1).

For example, the strip image creation unit 73 cuts the truncation area TR(n) from the boundary ML(L)-n to the boundary MR(L)-(n+1) on the captured image P(n) as the right eye strip image when the right eye strip image is cut from the captured image P(n). Here, the position of the boundary MR(L)-(n+1) on the captured image P(n) is the position on the captured image P(n) overlapped with the boundary MR(L)-(n+1) when the captured images P(n) and P(n+1) are arranged side by side. Hereinafter, the right eye strip image cut out from the captured image P(n) of the frame n will be referred to as a strip image TR(n).

Similarly, when the right eye strip image is cut out from the captured image P(n−1), the truncation area TR(n−1) from the boundary ML(L)-(n−1) to the boundary MR(L)-n on the captured image P(n−1) is cut out as the right eye strip image.

Therefore, the subject of the area from the boundary ML(L)-n to the boundary MR(L)-n on the strip image TR(n) becomes basically the same subject as the subject of the area from the boundary ML(L)-n to the boundary MR(L)-n on the strip image TR(n−1). However, since the strip images TR(n) and TR(n−1) are images cut out from the captured images P(n) and P(n−1), they have different angles when they are captured even if they have the same subject.

Similarly, in the strip image TR(n), the subject of the area from the boundary ML(L)-(n+1) to the boundary MR(L)-(n+1) is basically the same as the subject of the area from the boundary ML(L)-(n+1) to the boundary MR(L)-(n+1) in the strip image TR(n+1).

In addition, for example, the strip image creation unit 73 cuts out the truncation area TL(n) from the boundary ML(R)-n to the boundary MR(R)-(n+1) on the captured image P(n) as the left eye strip image when the left eye strip image is cut out from the captured image P(n). Here, the position of the boundary MR(R)-(n+1) on the captured image P(n) is the position of the captured image P(n) overlapped with the boundary MR(R)-(n+1) when the captured images P(n) and P(n+1) are arranged side by side. Hereinafter, the left eye strip image cut out from the captured image P(n) of the frame n will be referred to as a strip image TL(n).

In this manner, from the captured images, out of drawings on the captured images, the area defined by using the boundary located in the left side with respect to the center as the reference is cut out and set as the right eye strip image, and if those strip images are arranged side by side, the entire range (area) on the image capturing space as the image capturing target during capture of N captured images is displayed. A single image obtained by collectively synthesizing the right eye strip images obtained from each captured image becomes a panorama image corresponding to a single frame included in the right eye panorama moving picture.

Similarly, from the captured images, out of drawings on the captured images, the area defined by using the boundary located in the right side with respect to the center as the reference is cut out and set as the left eye strip image, and if those strip images are arranged side by side, the entire range on the image capturing space as the image capturing target is displayed. A single image obtained by collectively synthesizing the left eye strip images becomes a panorama image corresponding to a single frame included in the left eye panorama moving picture.

While the same subjects are displayed in both the right eye and left eye panorama images, a disparity occurs between those subjects. Therefore, when the right eye and left eye panorama images are simultaneously displayed, the subject on the panorama image appears in three dimensions to a user who observes the panorama image.

Returning to a description of the flowchart of FIG. 9, if the right eye and left eye strip images are obtained from the captured images, the process advances from step S51 to step S52.

In step S52, the 3D panorama moving picture creation unit 62 collectively synthesizes the strip image of each frame based on the coordinates of the center of the captured image and the right eye and left eye strip images to create the image data corresponding to a single frame of the 3D panorama moving picture.

That is, the 3D panorama moving picture creation unit 62 collectively synthesizes the right eye strip image to create the image data corresponding to a single frame of the right eye panorama moving picture and collectively synthesizes the left eye strip image to create the image data corresponding to a single frame of the left eye panorama moving picture. The image data obtained in this manner, i.e., the right eye panorama image and the left eye panorama image constitute a single frame of the 3D panorama moving picture.

For example, the 3D panorama moving picture creation unit 62 obtains pixel values of the pixels of the panorama image by a weighted sum for the area from the boundary ML(L)-n to the boundary MR(L)-n in the strip images TR(n) and TR(n−1) as the strip images TR(n) and TR(n−1) are synthesized as shown in FIG. 10.

That is, if the strip images TR(n) and TR(n−1) are arranged side by side based on the coordinates of the center, the areas of those strip images from the boundary ML(L)-n to the boundary MR(L)-n are overlapped to each other. The 3D panorama moving picture creation unit 62 performs weighted summing of pixel values of the pixels where the strip images TR(n) and TR(n−1) are overlapped to each other, and the resulting values are set to pixel values of the pixels of the panorama image of the position corresponding to those pixels.

In addition, in the strip images TR(n) and TR(n−1), the weight used in the weighted summing of the pixels of the area from the boundary ML(L)-n to the boundary MR(L)-n is determined to have the following characteristics.

Specifically, for the pixels of the position from the boundary LL-n to the boundary MR(L)-n, as the position of the pixel approaches the position of the boundary MR(L)-n from the boundary LL-n, the contribution of the pixel of the strip image TR(n) to the creation of the panorama image relatively increases. On the contrary, for the pixels of the position from the boundary LL-n to the boundary ML(L)-n, as the position of the pixel approaches the position of the boundary ML(L)-n from the boundary LL-n, the contribution of the pixel of the strip image TR(n−1) to the creation of the panorama image relatively increases.

When the panorama image is created, the area from the boundary MR(L)-n to the boundary ML(L)-(n+1) of the strip image TR(n) is directly used as a panorama image.

Furthermore, when the strip images TR(n) and TR(n+1) are synthesized, for the area from the boundary ML(L)-(n+1) to the boundary MR(L)-(n+1) in such a strip image, pixel values of the pixels of the panorama image are obtained through weighted summing.

Specifically, for the pixels of the position from the boundary LL-(n+1) to the boundary MR(L)-(n+1), as the position of pixel approaches the position of the boundary MR(L)-(n+1) from the boundary LL-(n+1), the contribution of the pixels of the strip image TR(n+1) to the creation of the panorama image relatively increases. On the contrary, for the pixels of the position from the boundary LL-(n+1) to the boundary ML(L)-(n+1), as the position of pixel approaches the position of the boundary ML(L)-(n+1) from the boundary LL-(n+1), the contribution of the pixels of the strip image TR(n) to the creation of the panorama image relatively increases.

Furthermore, similar to the case of the strip image TR(n), when the left eye strip image TL(n) and the strip image TL(n−1) are synthesized, or when strip image TL(n) and strip image TL(n+1) are synthesized, the weighted summing is also applied to the overlapping portions of those strip images.

In this manner, a value obtained by synthesizing the strip images and performing weighted summing of the area near the edge of the strip image of the consecutive frames is set to the pixel value of the pixel of the panorama image. As a result, in comparison with the case where a single image is obtained by simply arranging side by side the strip images.

For example, in the case where the panorama image is obtained by simply arranging side by side strip images, a distortion may occur in the contour of the subject near the corner of the strip image. If brightness of the strip image differs in the consecutive frames, brightness unevenness may occur in each area of the panorama image.

In this regard, in the 3D panorama moving picture creation unit 62, it is possible to prevent a distortion in the contour of the subject or brightness unevenness and obtain a more natural panorama image by synthesizing the area near the edge of the strip image through weighted summing.

In addition, during the position matching of the captured image, the motion estimation unit 61 may detect a lens distortion caused by an optical lens included in the image capturing unit 22, and the strip image creation unit 73 may correct the strip image using the detection result of the lens distortion during synthesizing of the strip image. In other words, based on the detection result of the lens distortion, the distortion occurring in the strip image is corrected by processing images.

The 3D panorama moving picture corresponding to a single frame obtained as described above is an image in which the area of the entire image capturing range on the image capturing space functioning as an image capturing target during capture of N captured images is used as the subject. As the 3D panorama moving picture corresponding to a single frame is created, the 3D panorama moving picture creation unit 62 supplies the image data of the created 3D panorama moving picture to the compression/decompression unit 27 through the bus 25.

In step S53, the compression/decompression unit 27 encodes the image data of the 3D panorama moving picture supplied from the 3D panorama moving picture creation unit 62, for example, based on a JPEG (Joint Photographic Experts Group) scheme and supplies it to the drive 28 through the bus 25.

The drive 28 supplies the recording medium 29 with the image data of the 3D panorama moving picture from the compression/decompression unit 27 and records it. During recording of the image data, 3D panorama moving picture creation unit 62 allocates a frame number to the image data.

In addition, in the case where the 3D panorama moving picture is recorded in the recording medium 29, the coordinates of the center and the moving subject information in addition to the 3D panorama moving picture may also be recorded in the recording medium 29.

In step S54, the signal processing unit 24 determines whether or not the image data of the 3D panorama moving picture is created as much as a predetermined amount of the frames. For example, in the case where it is assumed that the 3D panorama moving picture including the image data of M frames is created, it is determined that the 3D panorama moving picture corresponding to a predetermined number of frames when the image data corresponding to M frames is obtained.

In step S54, it is determined that the 3D panorama moving picture corresponding to a predetermined number of frames has not been created, the process returns to step S51, and the image data corresponding to the next frame of the 3D panorama moving picture is created.

For example, when 3D panorama moving picture for the right eye corresponding to a first frame of the 3D panorama moving picture is created, the truncation area TR(n) is cut out from the boundary ML(L)-n to the position of the boundary MR(L)-(n+1) of the captured image P(n) as the strip image as described above with reference to FIG. 10.

In the case where the right eye panorama image of the second and subsequent frames of the 3D panorama moving picture is created, the position of the truncation area TR(n) from the captured image P(n) is shifted to the left in FIG. 10 by a width CW ranging from the boundary LL-n to the boundary LL-(n+1).

In other words, the strip image of the (m)th frame of the right eye panorama moving picture is set to the strip image TR(n)-m (where, In this case, the start position of the strip image TR(n)-m of the (m)th frame is set to the position obtained by shifting the truncation area TR(n), which is the start position of the strip image TR(n)-1, to the left in FIG. 10 by a (m-1) multiple of the width CW.

Therefore, for example, the area for cutting out the strip image TR(n)-2 of the second frame has the same shape and size as those of the truncation area TR(n) in FIG. 10 for the captured image P(n), and the position of the right end thereof becomes the position of the boundary MR(L)-n.

Here, the shifting direction of the start area of the strip image is determined in advance depending on the pivot direction of the image capturing device 11 during capture of the image. For example, in the example of FIG. 10, for the center position of the captured image of a predetermined frame, it is assumed that the image capturing device 11 is pivoted such that the center position of the captured image of the next frame is typically located in the right side in the drawing. In other words, in the example of FIG. 10, it is assumed that the movement direction of the image capturing device 11 is the right direction in the drawing.

If the start position of the strip image is shifted for each frame in the direction opposite to the movement direction of the center position of the captured image caused by the movement of the image capturing device 11, the subject having no motion in each panorama image of the panorama moving picture is located in the same position.

Similar to the right eye panorama image, even in the case where the left eye panorama image is created, the position of the truncation area TL(n) of the strip image from the captured image P(n) is shifted in the left direction in FIG. 10 by the width ranging from the boundary RL-n to the boundary RL-(n+1).

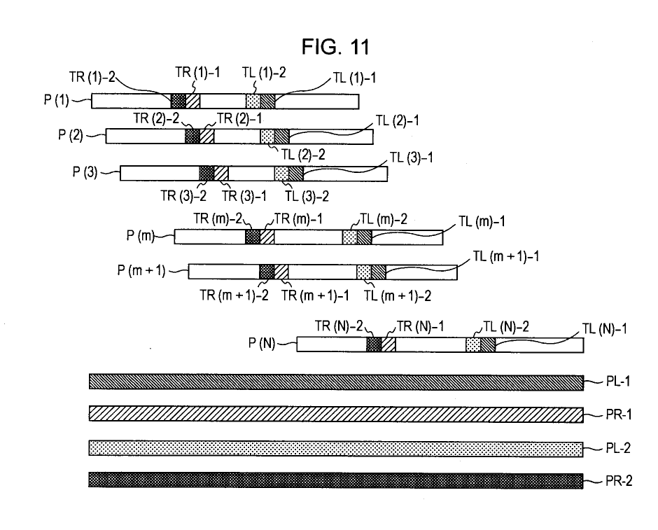

In this manner, if the image data of each frame of the panorama moving picture is created while the start position of the strip image is shifted in each frame, it is possible to obtain, for example, the 3D panorama moving picture as shown in FIG. 11. In addition, in FIG. 11, the horizontal direction of FIG. 11 corresponds to the horizontal direction of FIG. 10. For example, the horizontal direction of FIG. 11 corresponds to the x direction of the x-y coordinate system.

In the example of FIG. 11, the strip images TL(1)-1 to TL(N)-1 are created from each of N captured images P(1) to P(N) and synthesized to obtain the left eye panorama image PL-1.

Similarly, the strip images TL(1)-2 to TL(N)-2 are created from each of N captured images P(1) to P(N) and synthesized to obtain the left eye panorama image PL-2. The panorama images PL-1 and PL-2 are included in the first and second frames, respectively, of the left eye panorama moving picture.

The strip images TR(1)-1 to TR(N)-1 are created from each of N captured images P(1) to P(N) and synthesized to obtain the right eye panorama image PR-1.

Similarly, the strip images TR(1)-2 to TR(N)-2 are created from each of N captured images P(1) to P(N) and synthesized to obtain the right eye panorama image PR-2. The panorama images PR-1 and PR-2 are included in the first and second frames, respectively, of the right eye panorama moving picture.

Here, for example, the start position of the strip image TR(2)-2 in the captured image P(2) is obtained by shifting the start position of the strip image TR(2)-1 to the left side in the drawing by the width CW. The magnitude of the width CW varies in each frame of the captured image.

Furthermore, the same subjects are displayed, for example, in the strip images TL(1)-1 and TL(2)-2 at different time points. Similarly, the same subjects are displayed in the strip images TL(1)-1 and TR(m)-1 at different time points.

In this manner, the same subjects are displayed in each of the panorama images PL-1 to PR-2 at different time points. In addition, the right eye and left eye panorama images of each frame included in the 3D panorama moving picture have a disparity.

Since the panorama image is created by synthesizing the strip images obtained from the captured images of a plurality of different frames, the subject displayed in each area has a different capturing time point even in a single panorama image.

More specifically, ends of each panorama image are created using the captured images P(1) and P(N). For example, the left end of the panorama image PL-1 in the drawing includes the images ranging from the left end of the captured image P(1) to the right end of the strip image TL(1)-1.

Returning to the description of the flowchart of FIG. 9, if it is determined that the 3D panorama moving picture corresponding to a predetermined number of frames has been created in step S54, the signal processing unit 24 reads the panorama images of each frame included in the 3D panorama moving picture from the recording medium 29 through the drive 28. The signal processing unit 24 supplies the compression/decompression unit 27 with the read right eye and left eye panorama images and instructs decoding so that the process advances to step S55.

In step S55, the compression/decompression unit 27 decodes the image data of the 3D panorama moving picture supplied from the signal processing unit 24, i.e., the panorama image, for example, based on the JPEG scheme and supplies the result thereof to the signal processing unit 24.

In step S56, the signal processing unit 24 3D reduces the right eye and left eye panorama images of each frame included in the panorama moving picture from the compression/decompression unit 27 into a predetermined size. For example, the reduction processing is performed to provide a size capable of displaying the entire panorama image on the display screen of the display unit 31.

As the 3D panorama moving picture is reduced, the signal processing unit 24 supplies the display control unit 30 with the reduced 3D panorama moving picture. Alternatively, the reduced 3D panorama moving picture may be supplied and recorded to and in the recording medium 29.

In step S57, the display control unit 30 supplies the display unit 31 with the 3D panorama moving picture from the signal processing unit 24 and initiates reproduction of the 3D panorama moving picture. In other words, the display control unit 30 sequentially supplies the display unit 31 with each frame of the right eye and left eye panorama moving pictures with a predetermined time interval and displays them in three dimensions using a lenticular method.

Specifically, the display unit 31 displays the 3D panorama moving picture by dividing the right eye and left eye panorama images of each frame into several strip images and alternately arranging and displaying the divided right eye and left eye images in a predetermined direction. The light of the divided and displayed right eye and left eye panorama images is guided to the right and left eyes, respectively, of a user who watches the display unit 31 through the lenticular lens of the display unit 31. As a result, a 3D panorama moving picture is observed by eyes of a user.

As the 3D panorama moving picture is displayed (reproduced) on the display unit 31, the reproduction process of the 3D panorama moving picture is completed, and then, the process advances to step S18 of FIG. 6.

In this manner, the image capturing device 11 creates a plurality of right eye and left eye strip images from each of a plurality of images captured at different time points by shifting the truncation area, and creates the 3D panorama moving picture of each frame by synthesizing the strip images.

The 3D panorama moving picture created in this manner can express motion by allowing the captured subject to have motion and display the subject in three dimensions. Therefore, it is possible to more effectively display the image of the captured subject.

Furthermore, since the subjects of each area on a single panorama image are captured at different time points, a more exciting image can be represented. That is, it is possible to more effectively display the captured subject.

In the aforementioned description, once N captured images are captured, and all captured images are recorded in the buffer memory 26, the 3D panorama moving picture is created using those captured images. However, the 3D panorama moving picture may be created simultaneously with capture of the captured images.

In the aforementioned description, once the 3D panorama moving picture is created, and the 3D panorama moving picture is reduced. However, the reduced 3D panorama moving picture may be directly created from the captured images. In this case, since it is possible to further reduce the processing amount until the 3D panorama moving picture is reproduced, it is possible to more rapidly display the 3D panorama moving picture. In addition, a function of creating the 3D panorama moving picture from the captured images may be provided in a personal computer or the like, and the 3D panorama moving picture may be created from the captured images captured by a camera.

Description of 3D Partial Moving Picture Reproduction Process

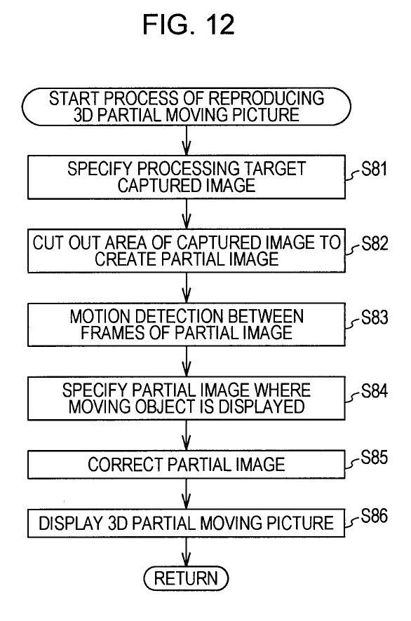

Next, a description will be provided for the 3D partial moving picture reproduction process corresponding to the process of step S19 of FIG. 6 with reference to the flow chart of FIG. 12. The 3D partial moving picture reproduction process is initiated as a predetermined position on the 3D panorama moving picture and a magnification are designated by a user, and the reproduction of 3D partial moving picture is instructed.

In step S81, the partial image creation unit 74 specifies a processing target captured image out of the captured images based on the coordinates of the center, the 3D panorama moving picture, and the captured images recorded in the buffer memory 26 in response to the signal from the manipulation input unit 21.

That is, the partial image creation unit 74 specifies the area defined by the designated magnification by a user with respect to the position designated by a user on the panorama image of the 3D panorama moving picture. Specifically, when the reduced and displayed panorama image is magnified by the designated magnification and displayed, the area having a size that can be displayed on the display unit 31 is specified. As a result, for example, the area BP of FIG. 3 is specified as the area displayed as the 3D partial moving picture.

The partial image creation unit 74 sets the captured image where the subject included in the area BP is displayed as the processing target captured image. In other words, when each captured image is arranged on the x-y coordinate system, the area on the x-y coordinate system corresponding to the area BP within the captured image out of a plurality of captured images is regarded as the processing target captured image. Therefore, the captured images of a plurality of consecutive frames are specified as the processing target.

In step S82, the partial image creation unit 74 creates the particular image by cutting out the area where the subject is displayed in the area BP in the captured image using the coordinates of the center of the captured image for the processing target captured image. As a result, it is possible to obtain the partial image of a plurality of consecutive frames.

In step S83, the motion detection unit 75 detects motion between frames of the obtained partial images. That is, the motion detection unit 75 performs motion estimation using the partial image of two consecutive frames and arranges two partial images on a predetermined plane such that the subjects having no motion are overlapped based on the result thereof. The motion detection unit 75 obtains the difference in the pixel values of the pixels of each area for the overlapping portions of those partial images and detects the moving subject.

For example, in the partial image, when the area having a predetermined or larger size including the pixels where the absolute value of the difference in the pixel values is equal to or larger than a predetermined value is detected, such an area is set to the area of the moving subject. In this manner, all of the partial images, a difference between two partial images is obtained, and the moving subject is detected.

As a result, it is possible to recognize from which frame the moving subject is represented on the partial image and where frame the moving subject displayed until now is not displayed from the detection result of the moving subject and the partial image. In addition, it is possible to identify each moving subject through block matching or the like from the detection result of the moving subject and the partial image.

In step S84, the motion detection unit 75 specifies the partial image where the moving subject is displayed out of the partial images of a plurality of consecutive frames based on the detection result of the moving subject from the partial image.

In step S85, the correction unit 76 corrects the partial image based on the detection result of the moving subject and the result of specifying the partial image included in the moving subject.

For example, out of the consecutive partial images of the frames 1 to 4, while the moving subject is not included in the partial images of the frames 1 and 4, the same moving subject is included in the partial images of the frames 2 and 3. Since the capturing time point of the captured image is different in those frames, the moving subject is displayed in a different position for each frame.

In this case, the correction unit 76 cuts out the area of the partial image of the frame 1 that is provided in the same position as that of the area including the moving subject on the partial image of the frame 2 based on the detection result of the moving subject, and sets the area as the substitution image. The correction unit 76 corrects the partial image of the frame 2 by substituting the area near the moving subject on the partial image of the frame 2 with the substitution image obtained by the truncation, i.e., by attaching the substitution image with the partial image of the frame 2.

The substitution image cut out from the partial image of the frame 1 has the same background as the still background behind the moving subject of the partial image of the frame 2. That is, such correction is a process of substituting the image of the area near the moving subject on the processing target partial image with the image of the area corresponding to the moving subject on the processing target partial image out of other partial images where the moving subject is not displayed unlike the image of the area near the moving subject on the processing target partial image.

Through the correction process, the moving subject of the partial image of the frame 2 is moved to the background behind the moving subject so that the moving subject is removed from the partial image without an uncomfortable feeling.

In addition, since the partial images of the frames 1 and 2 have a disparity from each other, more specifically, it is possible to attach the substitution image based on the subject commonly included between the substitution image and the image of the area near the moving subject of the partial image of the frame 2. In other words, when the partial image of the frame 2 and the substitution image are arranged such that the subjects included in those images are overlapped with each other, the area overlapped with the substitution image is substituted with the substitution image in the partial image of the frame 2. As a result, it is possible to prevent the partial images obtained after the correction from being an uncomfortable image due to the effect of the disparity.

Similarly, the correction unit 76 cuts out the area of the partial image of the frame 1 located in the same position as the area including the moving subject on the partial image of the frame 3 based on the detection result of the moving subject and sets it as the substitution image. The correction unit 76 substitutes the area near the moving subject on the partial image of the frame 3 with the substitution image. As a result, the partial image of the frame 3 is also corrected, and the moving subject is removed from the partial image.

In the partial image of the frame 2, in the case where the moving subject is not provided in the same area as the area where the moving subject is provided in the partial image of the frame 3, the substitution image may be created from the partial image of the frame 2. In this case, the substitution image cut out from the partial image of the frame 2 is attached to the partial image of the frame 3 so that the partial image of the frame 3 is corrected.

In order to suppress the effect of the disparity to minimum, the frame where the substitution image is cut out is preferably set to the frame located in the nearest position from the processing target frame including the moving subject.

In this manner, in the case where the moving subject is included in the partial image for all of the partial images of a plurality of the consecutive frames, the correction unit 76 corrects the image of that area. As a result, it is possible to obtain the partial image of a plurality of consecutive frames where the moving subject is not included.

Subsequently, the 3D partial moving picture creation unit 63 creates the 3D partial moving picture from the corrected partial image of the consecutive frames based on a predetermined magnitude of the disparity of the 3D partial moving picture.

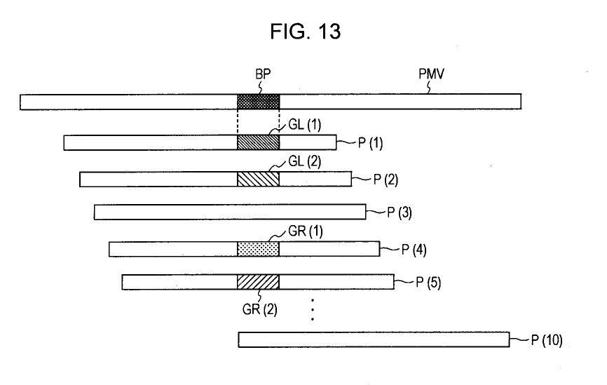

For example, as shown in FIG. 13, the partial images of 10 consecutive frames are created from the captured images P(1) to P(10) of 10 consecutive frames, and those partial images are corrected as necessary.

In addition, in FIG. 13, like reference numerals denote like elements as in FIG. 3, and descriptions thereof will be omitted. In FIG. 13, the horizontal direction corresponds to the horizontal direction of FIG. 10, i.e., the x direction of the x-y coordinate system.

In FIG. 13, each captured image and each panorama image (3D panorama moving picture PMV) are arranged side by aside such that the same subjects on those images have the same position in the horizontal direction, the area GL(1) is cut out from the captured image P(1) and used as the partial image. In addition, the area GL(2) is cut out from the captured image P(2) and used as the partial image. For example, the areas GR(1) and GR(2) are cut out from the captured images P(4) and P(5) and used as the partial images.

Here, the areas GL(1) and GR(2) are the areas where the subject is displayed within the area BP. In other words, in the case where the captured images area arranged side by side in the x-y coordinate system, the area of the captured image located in the same position as the area BP is cut out and used as the partial image.

In this manner, as the partial images are created from each of the images P(1) to P(10), those partial images are corrected as necessary, and, for example, the moving subject is removed from the partial images. Then, the 3D partial moving picture creation unit 63 creates the 3D partial moving picture made from the partial moving picture pair having a disparity from each other based on the magnitude of the disparity of the predetermined 3D partial moving picture.

For example, the partial images obtained from the captured images P(1) to P(7) are used as the partial images of the first to seventh frames, respectively, of the left eye partial moving picture. In addition, the partial images obtained from the captured images P(4) to P(10) are used as the partial images of the first to seventh frames, respectively, of the right eye partial moving picture. As a result, it is possible to obtain the 3D partial moving picture of a total of 7 frames made from the right eye and left eye partial moving pictures.

Here, the captured images P(1) to P(4) used to create the first frame of the 3D partial moving picture have a predetermined magnitude of the disparity. In this manner, if the left eye and right eye partial images of the first frame of the 3D partial moving picture are selected so as to have a predetermined magnitude of the disparity, and the partial images of the consecutive frames obtained by using such a frame as a leading end are used as the right eye and left eye partial moving pictures, it is possible to obtain the 3D partial moving picture having an appropriate disparity.

Then, if the 3D partial moving picture obtained in this manner is reproduced, it is possible to give a perspective to the displayed subject and display a 3D image having depth.

While, in the aforementioned description, as an example of correcting the partial image, the moving subject is removed from the partial images, the partial images may be corrected such that the same moving subject is displayed in the same position as the left eye and right eye partial images of the same frame of the 3D partial moving picture.

In this case, the 3D partial moving picture creation unit 63 creates the 3D partial moving picture from the partial images of the consecutive frames before correction based on the predetermined magnitude of the disparity of the 3D partial moving picture. For example, in the example of FIG. 13, the partial images obtained from the captured images P(1) to P(7) are used as the partial images of the first to seventh frames, respectively, of the left eye partial moving picture. In addition, the partial images obtained from the captured images P(4) to P(10) are used as the partial images of the first to seventh frames, respectively, of the right eye partial moving picture, so that it is possible to obtain the 3D partial moving picture of a total of 7 frames made from such two partial moving pictures.

As the 3D partial moving picture is obtained, the correction unit 76 corrects the each of the partial images of the 3D partial moving picture based on the detection result of the moving subject and the result of specifying the partial images where the moving subject is included.

Specifically, the correction unit 76 compares the right eye and left eye partial images of the first frame of the 3D partial moving picture. As a result, for example, it is assumed that in such a partial image, a vehicle as the still subject and a man as the moving subject are included, the man is located in a position having a certain distance from the vehicle in the right eye frame, and the man is located near the vehicle in the left eye frame.

In this case, the correction unit 76 cuts out the image of the area including the vehicle and the man in the partial image of the first frame as the substitution image. That is, in the right eye partial image, the area including both the moving subject on the partial image and the area located in the same position as the moving subject on the left eye partial image is cut out as the substitution image.

The correction unit 76 corrects the left eye partial image of the first frame by substituting the area corresponding to the substitution image including the man in the left eye partial image of the first frame. That is, the substitution image can be attached to the area in the left eye partial image including both the moving subject on the left eye partial image and the area located in the same position as the moving subject on the right eye partial image.

Even in this case, when the left eye partial image and the substitution image are arranged such that the same subjects having no motion included in such an image are overlapped, the area of the partial image overlapped with the substitution image is substituted with the substitution image in order to suppress the effect of the disparity.

As the left eye partial image of the first frame is corrected in this manner, the man is displayed to be apart from the vehicle with a certain distance in the right eye and left eye partial images of the first frame. That is, the same moving subjects are displayed in each of the positions corresponding to left eye and right eye partial images. As a result, when such a partial image is displayed in three dimensions using a lenticular method or the like, it is possible to display the moving subject in three dimensions without an uncomfortable feeling.

Similarly, the correction unit 76 compares the left eye and right eye partial images of the same frame for each frame included in the 3D partial moving picture, and cuts out the substitution image from the right eye partial image, so that the substitution image is attached to the left eye partial image.

For example, in the case where the moving subject is displayed in the left eye partial image while the moving subject is not displayed in the right eye partial image, the area of the right eye partial image located in the same position as that of the moving subject of the left eye partial image is cut out as the substitution image. Then, the obtained substitution image can be attached to the left eye partial image so that the moving subject is removed from the left eye partial image.

On the contrary, in the case where the moving subject is not displayed in the left eye partial image while the moving subject is displayed in the right eye partial image, the area of the moving subject in the right eye partial image is cut out as the substitution image. The substitution image can be attached to the area in the left eye partial image located in the same position as that of the moving subject of the right eye partial image so that the moving subject is added to the left eye partial image.

In this manner, as the left eye partial image is corrected as necessary, the 3D partial moving picture creation unit 63 selects the partial moving picture pair including the right eye and left eye partial moving pictures after the correction as a final 3D partial moving picture.

In the case where the moving subject is not included in the left eye and right eye partial images of the same frame, the correction for the partial images of that frame is not performed. That is, in the case where the moving subject is included in any one of the left eye and right eye of the same frame, or in the case where the moving subject is included in both the left and right eyes of the same frame, and the display positions of those moving subjects are different, the left eye partial image is corrected.

While, in the aforementioned descriptions, the left eye partial image is corrected by using the right eye partial image as a reference, the right eye partial image may be corrected by using the left eye partial image as a reference.

In addition, when the moving subject is displayed apart from each other in the left eye and right eye partial images of the same frame, the substitution image may be created for each of those moving subjects.

For example, the area on the right eye partial image where the moving subject is included is cut out as the substitution image, and the substitution image may be attached to the area of the left eye partial image located in the same position as that of the moving subject of the right eye partial image. As a result, the moving subject in the left eye partial image is displayed in nearly the same position as that of the moving subject of the right eye partial image.

Furthermore, the area of the right eye partial image located in the same position as that of the moving subject of the left eye partial image is cut out as the substitution image, and the substitution image may be attached to the area in the left eye partial image where the moving subject is included. As a result, the moving subject originally provided is removed from the left eye partial image.

In this case, the substitution image attached to the area of the left eye partial image where the moving subject is included may be created from not the right eye partial image but the left eye partial image of the frame near the frame of the processing target left eye partial image. That is, in the left eye partial image of the frame located in the nearest position from the processing target frame, a partial image where the moving subject is not displayed is specified in the same position as that of the moving subject of the left eye partial image of the processing target frame is specified, and the substitution image is created from the specified partial image.

Returning to the description of the flowchart of FIG. 12, as the partial image is corrected in step S85, and the 3D partial moving picture is obtained, the 3D partial moving picture creation unit 63 supplies the display control unit 30 with the obtained 3D partial moving picture through the bus 25, and the process advances to step S86.

In step S86, the display control unit 30 supplies the display unit 31 with the 3D partial moving picture supplied from the 3D partial moving picture creation unit 63 and displays it. That is, the display control unit 30 sequentially supplies the display unit 31 with the right eye and left eye partial image pairs included in each frame of the 3D partial moving picture with a predetermined time interval and displays them in three dimensions using a lenticular method.

The created 3D partial moving picture is displayed, and the 3D partial moving picture may be further supplied from the 3D partial moving picture creation unit 63 to the drive 28 to be recorded in the recording medium 29.

As the 3D partial moving picture is displayed in the display unit 31, the process of reproducing the 3D partial moving picture is terminated, and then, the process of reproducing the moving picture of FIG. 6 is also terminated.

In this manner, the image capturing device 11 creates the partial image where the specified area is displayed depending on the size of the area to be displayed on the image capturing space as the image capturing target, i.e., the position specified on the panorama image and the magnification. The image capturing device 11 appropriately corrects a plurality of the obtained partial images and creates the 3D partial moving picture from the corrected partial images.

In this manner, it is possible to obtain a more natural 3D image without an uncomfortable feeling by removing the moving subject from the left eye and right eye partial images of the 3D partial moving picture through correction of the partial images or displaying the moving subject in nearly the same position in the left eye and right eye partial images.

In addition, when the position on the 3D panorama moving picture and the magnification are specified, a 3D partial image including the right eye and left eye partial images may be displayed without displaying the 3D partial moving picture. In this case, for example, a pair of the partial images cut out from the areas GL(1) and GR(1) of FIG. 13 are corrected and displayed as a 3D partial image.

In addition, it is possible to remove the moving picture from the 3D panorama moving picture or display the moving subject in nearly the same positions of the left eye and right eye panorama images by performing the process described with reference to FIG. 12 for the 3D panorama moving picture. In this case, the moving subject is detected from the panorama image of the consecutive frames for each of the right and left eyes to correct each panorama image.

Description of Process of Displaying 3D Panorama Image

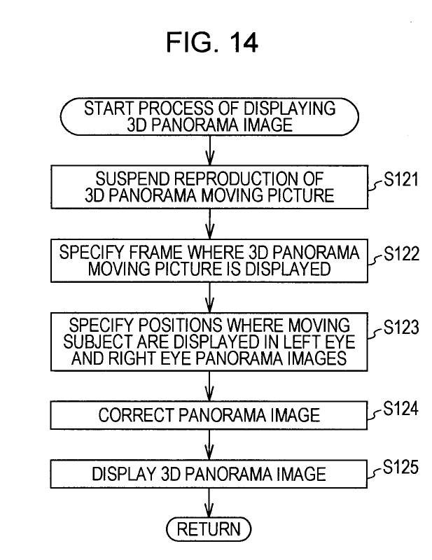

Next, a process of displaying the 3D panorama image corresponding to the process of step S21 of FIG. 6 will be described with reference to the flowchart of FIG. 14. The process of displaying the 3D panorama image is initiated as displaying of the 3D panorama image is instructed during reproduction of the 3D panorama moving picture.

In step S121, the signal processing unit 24 controls the display control unit 30 in response to the signal from the manipulation input unit 21 to suspend reproduction of the 3D panorama moving picture. As a result, the 3D panorama moving picture displayed in three dimensions in the display unit 31 is suspended (paused).

In addition, by allowing a so-called frame-by-frame playback manipulation, a user may manipulate the manipulation input unit 21 to display the frame before or after that frame in the display unit 31 even after reproduction of the 3D panorama moving picture is suspended. As a result, a user is allowed to suspend reproduction of the 3D panorama moving picture while a desired frame is displayed in the display unit 31.

In step S122, the 3D panorama image creation unit 64 specifies the frame displayed in the display unit 31 from the suspended 3D panorama moving picture. Then, the 3D panorama image creation unit 64 obtains left eye and right eye panorama images of the specified frame of the 3D panorama moving picture from the signal processing unit 24.

For example, in the case where the 3D panorama moving picture is reproduced, the signal processing unit 24 stores the decoded 3D panorama moving picture before reduction until the reproduction is terminated. The 3D panorama image creation unit 64 obtains the right eye and left eye panorama images of the specified frame before reduction from the signal processing unit 24. In addition, the 3D panorama image creation unit 64 also obtains the N captured images, the coordinates of the center, and the moving subject information from the buffer memory 26.

In step S123, the 3D panorama image creation unit 64 specifies the position where the moving subject is displayed on the right eye and left eye panorama images of the obtained frame based on the coordinates of the center and the moving subject information.

For example, the 3D panorama image creation unit 64 can specify which area of the processing target panorama image is created from which area of which captured image using the processing target frame number and the coordinates of the center. Furthermore, as the captured image used to create each area of the panorama image, the 3D panorama image creation unit 64 can specify where the moving subject is displayed on the panorama image from the moving subject information of that captured image. In other words, the display position of the moving subject on the panorama image is specified.

In step S124, the correction unit 77 corrects the panorama image based on the result of specifying the display position of the moving subject, the captured images, the coordinates of the center, and the moving subject information.

For example, it is assumed that the moving subject is displayed in a predetermined position of the right eye panorama image, and the portion where the moving subject is displayed is created by using the captured image P(n). In this case, the correction unit 77 specifies the captured image where the moving subject is not displayed in the same position as that of the moving subject on the captured image P(n), as the captured image of the frame located in the nearest position from the frame of the captured image P(n), based on the moving subject information.

The correction unit 77 cuts out the area of the in the specified captured image which is the same as the area where the moving subject is included on the captured image P(n) and sets it as the substitution image. The correction unit 77 corrects the right eye panorama image by substituting the area near the moving subject on the right eye panorama image with the obtained substitution image.

The substitution image cut out from the captured image is an image where the same background as the still background behind the moving subject of the right eye panorama image is displayed. That is, the correction is a process of substituting the image in the area near the moving subject on the panorama image with the image of the area corresponding to the moving subject on the panorama image in other captured images where the moving subject is not displayed unlike the captured image used to create that area.

Through the correction, the moving subject on the right eye panorama image is substituted with the background behind that moving subject, so that the moving subject is removed from the panorama image without an uncomfortable feeling.

More specifically, when the substitution image is attached, in the case where the panorama image and the substitution image are arranged such that the same subjects included in those images are overlapped in order to suppress the effect of the disparity, the area overlapped with the substitution image in the panorama image is substituted with the substitution image.

Similar to the case of the right eye, the correction unit 77 also removes the moving subject from the left eye panorama image. In the case where the moving subject is not included in the panorama image, the correction of the panorama image is not performed. The 3D panorama image creation unit 64 uses a pair of the corrected right eye and left eye panorama images as a final 3D panorama image. In this manner, if the 3D panorama image is obtained by removing the moving subject from the panorama image and displayed in three dimensions, it is possible to display a more natural 3D image without an uncomfortable feeling.

While, in the aforementioned description, the moving subject is removed from the panorama image as an example of correction of the panorama image, the panorama image may be corrected such that the same moving subject can be displayed in nearly the same position of the left eye and right eye panorama images of the 3D panorama image.

In such a case, the correction unit 77 corrects such a panorama image by attaching the same substitution image cut out from the captured image to the left eye and right eye panorama images based on the result of specifying the display position of the moving subject, the captured images, the coordinates of the center, and the moving subject information.

For example, it is assumed that a stopped vehicle and a man as the moving subject are displayed in the left eye and right eye panorama images, the man is located in a position having a certain distance from the vehicle in the right eye panorama image, and the man is located near the vehicle in the left eye panorama image. In addition, the area near the man in the right eye panorama image is created and specified from the captured image P(n).

In this case, the correction unit 77 cuts out the image of the area where the vehicle and the man are included from the captured image P(n) as the substitution image. In other words, in the case where the captured image P(n) and the panorama image are arranged side by side in the x-y coordinate system such that the same subjects having no motion are overlapped, the area where both the moving subject on the captured image and the area of the same position as that of the moving subject on the left eye panorama image are included is cut out from the captured image P(n).

The correction unit 77 corrects the right eye and left eye panorama images by substituting the area where the man corresponding to the substitution image is included with the substitution image in the right eye and left eye panorama images. Even in this case, when the panorama images and the substitution image are arranged such that the same subjects included in those images are overlapped in order to suppress the effect of the disparity, the area overlapped with the substitution image in the panorama image is substituted with the substitution image.

As the left eye and right eye panorama images are corrected in this manner, the man as the moving subject is displayed in the position apart from the vehicle with a certain distance on those panorama images. In other words, if the same moving subjects are displayed in the corresponding positions of the left eye and right eye panorama images, and such panorama image is displayed in three dimensions using a lenticular method or the like, it is possible to display the moving subject in three dimensions without an uncomfortable feeling.

The 3D panorama image creation unit 64 sets a pair of the left eye and right eye panorama images corrected as described above as the 3D panorama image.

In addition, in the case where the moving subject is not displayed on either the left eye or right eye panorama images, the correction of the panorama image is not performed. In other words, in the case where the moving subject is included in at least any one of the left eye and right eye panorama images, the correction of the panorama image is performed.

In addition, in the case where the moving subjects are displayed apart from each other in the left eye and right eye panorama images, the substitution image may be created for each of the moving subjects.

For example, the portion of the moving subject is cut out from the captured image used to create the portion of the moving subject on the right eye panorama image as the substitution image, and the substitution image may be attached to the area of the portion of the moving subject on the right eye panorama image. In addition, the substitution image may be attached to the area of the same position in the left eye panorama image as that of the moving subject on the right eye panorama image. As a result, two moving subjects are displayed in the left eye panorama image, including the moving subject that has been already present and the moving subject displayed through correction.

In this regard, the correction unit 77 further specifies the captured image where the moving subject is not displayed in the same position as that of the moving subject on the captured image P(n) as the captured image of the frame located in the nearest position from the frame of the captured image P(n) used to create the portion of the moving subject on the left eye panorama image.

The correction unit 77 cuts out the same area in the specified captured image as that is included in the moving subject on the captured image P(n) as the substitution image and substitutes the area near the moving subject that has been already present on the left eye panorama image with the substitution image. As a result, the moving subject that has been already present in the left eye panorama image is removed. Through the aforementioned correction, it is possible to correct the panorama image such that the same moving subject is displayed in the position corresponding to each of the left eye and right eye panorama images.

In this case, in order to remove the moving subject that has been already present from the left eye panorama image, the area of the right eye of the panorama image located in the same position as that of the left eye panorama image where that moving subject exists may be used as the substitution image. The substitution image obtained in this manner may be attached to the position of the moving subject of the left eye panorama image to remove the moving subject. However, in this case, it is assumed that the moving subject of the right eye panorama image does not exist in the same position as that of the moving subject of the left eye panorama image.

Returning to the description of the flowchart of FIG. 14, if a 3D panorama image is obtained by correcting the panorama image in step S124, the 3D panorama image creation unit 64 supplies the display control unit 30 with the obtained 3D panorama image, and the process advances to step S125.

In step S125, the display control unit 30 supplies the display unit 31 with the 3D panorama image supplied from the panorama image creation unit 64 and displays it. In other words, the display control unit 30 supplies the display unit 31 with a pair of the right eye and left eye panorama images of the 3D panorama image and displays them in three dimensions using a lenticular method.

In addition, even when the created 3D panorama image is displayed, the 3D panorama image may also be supplied from the 3D panorama image creation unit 64 to the drive 28 and recorded in the recording medium 29.

As the 3D panorama image is displayed in the display unit 31, the process of displaying the 3D panorama image is terminated, and then, the process of reproducing the moving picture in FIG. 6 is also terminated.

In this manner, the image capturing device 11 creates the 3D panorama image by correcting the panorama image of a particular image included in the 3D panorama moving picture that is being reproduced.

In this manner, it is possible to obtain a more natural 3D image without an uncomfortable feeling by removing the moving subject from the panorama image of the 3D panorama image through the correction of the panorama image and displaying the moving subject in nearly the same positions as those of the left and right panorama images.

A series of the aforementioned processes may be executed via hardware or software. In the case where the processes are executed in software, a program included in the software is installed from a program recording medium to a computer embedded in dedicated hardware or, for example, a general purpose personal computer capable of executing various functions by installing various programs.

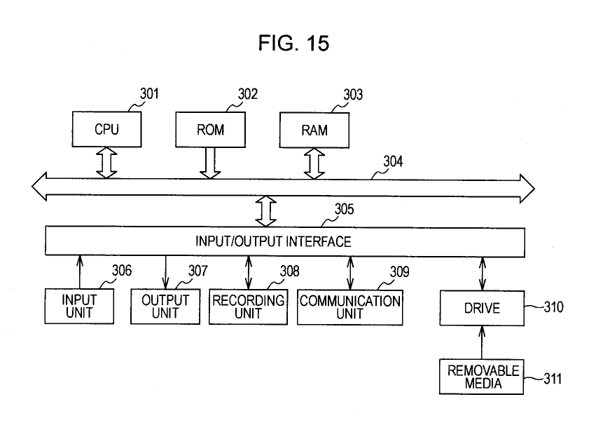

FIG. 15 is a block diagram illustrating an exemplary hardware structure of a computer for executing a series of the aforementioned processes using a program.

In the computer, the CPU (Central Processing Unit) 301, the ROM (Read Only Memory) 302, and the RAM (Random Access Memory) 303 are connected to each other through the bus 304.

Furthermore, the input/output interface 305 is connected to the bus 304. The input/output interface 305 is connected to the input unit 306 such as a keyboard, a mouse, or a microphone, the output unit 307 such as a display or a loudspeaker, a recording unit 308 such as a hard disc or a non-volatile memory, the communication unit 309 such as a network interface, and the drive 310 for driving a removable medium 311 such as a magnetic disc, an optical disc, or a semiconductor memory.

In the computer configured as describe above, a series of the aforementioned processes are executed in the CPU 301, for example, such that a program recorded in the recording unit 308 is loaded and executed on the RAM 303 through the input/output interface 305 and the bus 304.

The program executed by the computer (CPU 301) is recorded in a removable medium 311 or a package medium such as a magnetic disc (including a flexible disc), an optical disc (such as a CD-ROM (Compact Disc-Read Only Memory) or a DVD (Digital Versatile Disc)), an optical magnetic disc, or a semiconductor memory or provided via a wired/wireless transmission medium such as a local area network, the Internet, or a digital satellite broadcasting.

In addition, the program may be installed in the recording unit 308 through the input/output interface 305 by installing the removable medium 311 in the drive 310. The program may be received by a communication unit 309 via a wired/wireless transmission medium and installed in the recording unit 308. In addition, the program may be installed in advance in the ROM 302 or the recording unit 308.

The program executed by the computer may be a program processed according to the time sequence described in the present specification or processed in parallel or at a desired timing such as when it is called.

The present application contains subject matter related to that disclosed in Japanese Priority Patent Application JP 2009-235405 filed in the Japan Patent Office on Oct. 9, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing device comprising:
an output image creation means configured to create a plurality of consecutive output images where a particular area as an image capturing target is displayed during image capture of images to be captured based on a plurality of captured images obtained through the image capturing in an image capturing means while moving the image-capturing means;
a detection means configured to detect a moving subject having motion from the output images based on motion estimation using the output images;
a correction means configured to correct a predetermined output image to remove the moving subject included in the predetermined output image based on a result of detection of the moving subject by substituting a subject area, where the moving subject of the predetermined output image is displayed, with an image of an area corresponding to the subject area of another different output image when the moving subject is included in the predetermined output image; and
a 3D output image creation means configured to create a 3D output image including the output image having a predetermined disparity from the predetermined output image out of a plurality of the output images and the corrected predetermined output image.

2. The image processing device according to claim 1, wherein the output image creation means cuts an area, where the particular area is displayed, from a plurality of the captured images and creates a plurality of the output images.

3. The image processing device according to claim 2, wherein the correction means corrects the output image by substituting the subject area of the output image with an image of an area, where the moving subject of another different output image is not displayed, corresponding to the subject area when the output images include the moving subject for each of a plurality of the output images, and
the 3D output image creation means creates a 3D output image group including a first output image group having the output images obtained from a plurality of consecutively captured images and a second output image group having the output images obtained from a plurality of the consecutively captured images and having a disparity from the first output image group out of a plurality of the output images including the corrected output image.

4. The image processing device according to claim 2, wherein the correction means corrects the first output image by substituting the subject area of the first output image with an image of an area of the second output image corresponding to the subject area when the moving subject is included in the first output image, and the moving subject is included in an area corresponding to the subject area of the first output image in the second output image as the output image having a disparity from the first output image out of a plurality of the output images, for the first output image group having the first output images as the output images obtained from several consecutively captured images, and
the 3D output image creation means creates the 3D output image group including the corrected first output image group and a second output image group having each of the second output images having a disparity from each of the first output images included in the first output image group.

5. An image processing method of an image processing device including
an output image creation means configured to create a plurality of consecutive output images where a particular area as an image capturing target is displayed during capture of images to be captured based on a plurality of captured images obtained through the image capturing in an image capturing means while moving the image-capturing means,
a detection means configured to detect a moving subject having motion from the output images based on motion estimation using the output images,
a correction means configured to correct a predetermined output image to remove the moving subject included in the predetermined output image based on a result of detection of the moving subject by substituting a subject area, where the moving subject of the predetermined output image is displayed, with an image of an area corresponding to the subject area of another different output image when the moving subject is included in the predetermined output image, and
a 3D output image creation means configured to create a 3D output image including the output image having a predetermined disparity from the predetermined output image out of a plurality of the output images and the corrected predetermined output image,
the image processing method comprising the steps of:
creating a plurality of the consecutive output images based on the captured images using the output image creating means;
detecting the moving subject from the output image using the detection means;
correcting the predetermined output image using the correction means in the case where the moving subject is included in the predetermined output image; and
creating the 3D output image using the 3D output image creation means.

6. A program configured in a computer to execute processing including the steps of:
creating a plurality of consecutive output images where a particular area as an image capturing target is displayed during capture of images to be captured based on a plurality of captured images obtained through the image capturing using an image capturing means while moving the image-capturing means,
detecting a moving subject having motion from the output images based on motion estimation using the output images,
correcting a predetermined output image to remove the moving subject included in the predetermined output image based on a result of detection of the moving subject by substituting a subject area, where the moving subject of the predetermined output image is displayed, with an image of an area corresponding to the subject area of another different output image when the moving subject is included in the predetermined output image, and
creating a 3D output image including the output image having a predetermined disparity from the predetermined output image out of a plurality of the output images and the corrected predetermined output image.

7. An image processing device comprising:
a strip image creation means configured to create a first strip image by cutting a predetermined area on the captured image for each of a plurality of captured images obtained using an image capturing means while moving the image capturing means and create a second strip image by cutting an area different from the predetermined area on the captured image;
a panorama image creation means configured to create a 3D panorama image including first and second panorama images having a disparity from each other by collectively synthesizing each of the first and second strip images obtained from a plurality of the captured images and displaying the same area on an image capturing space used as an image capturing target during capture of a plurality of the images to be captured;
a detection means configured to detect a moving subject having motion from the captured images based on motion estimation using the captured images; and
a correction means configured to correct the first panorama image to remove the moving subject included in the first panorama image based on a result of detection of the moving subject by substituting a subject area included in the moving subject on the first panorama image with an image of an area corresponding to the subject area on the captured image when the moving subject is included in the first panorama image.

8. The image processing device according to claim 7, wherein the correction means corrects the first panorama image by substituting the subject area on the first panorama image with an image of an area corresponding to the subject area, where the moving subject on the captured image is not displayed, when the moving subject is included in the first panorama image, and
the correction means corrects the second panorama image by substituting the subject area on the second panorama image with an image of an area corresponding to the subject area, where the moving subject on the captured image is not displayed, when the moving subject is included in the second panorama image.

9. The image processing device according to claim 7, wherein, when the moving subject is included in the first panorama image, the correction means corrects the first panorama image by substituting the subject area on the first panorama image with an image of an area corresponding to the subject area, where the moving subject on the captured image is displayed, and the correction means corrects the second panorama image by substituting an area of the second panorama image corresponding to the subject area with an image of an area corresponding to the subject area, where the moving subject on the captured image is displayed.

10. An image processing method of an image processing device including
a strip image creation means configured to create a first strip image by cutting a predetermined area on the captured image for each of a plurality of captured images obtained using an image capturing means while moving the image capturing means and create a second strip image by cutting an area different from the predetermined area on the captured image;
a panorama image creation means configured to create a 3D panorama image including first and second panorama images having a disparity from each other by collectively synthesizing each of the first and second strip images obtained from a plurality of the captured images and displaying the same area on an image capturing space used as an image capturing target during capture of a plurality of the images to be captured;
a detection means configured to detect a moving subject having motion from the captured images based on motion estimation using the captured images; and
a correction means configured to correct the first panorama image to remove the moving subject included in the first panorama image based on a result of detection of the moving subject by substituting a subject area included in the moving subject on the first panorama image with an image of an area corresponding to the subject area on the captured image when the moving subject is included in the first panorama image,
the image processing method comprising the steps of:
creating first and second strip images from the captured images using the strip image creation means;
creating the first and second panorama images by collectively synthesizing each of the first and second strip images using the panorama image creation means;
detecting the moving subject from the captured images using the detection means; and
correcting the first panorama image based on a result of detection of the moving subject using the correction means when the moving subject is included in the first panorama image.

11. A program configured in a computer to execute processing including the steps of:
creating a first strip image by cutting a predetermined area on a captured image for each of a plurality of captured images obtained using an image capturing means while moving the image capturing means and a second strip image by cutting an area different from the predetermined area on the captured image;
creating a 3D panorama image including first and second panorama images having a disparity from each other by collectively synthesizing each of the first and second strip images obtained from a plurality of the captured images and displaying the same area on an image capturing space used as an image capturing target during capture of a plurality of the images to be captured;
detecting a moving subject having motion from the captured images based on motion estimation using the captured images; and
correcting the first panorama image to remove the moving subject included in the first panorama image based on a result of detection of the moving subject by substituting a subject area included in the moving subject on the first panorama image with an image of an area corresponding to the subject area on the captured image when the moving subject is included in the first panorama image.

12. An image processing device comprising:
an output image creation unit configured to create a plurality of consecutive output images where a particular area as an image capturing target is displayed during image capture of images to be captured based on a plurality of captured images obtained through the image capturing in an image capturing unit while moving the image-capturing unit;
a detection unit configured to detect a moving subject having motion from the output images based on motion estimation using the output images;
a correction unit configured to correct a predetermined output image to remove the moving subject included in the predetermined output image based on a result of detection of the moving subject by substituting a subject area, where the moving subject of the predetermined output image is displayed, with an image of an area corresponding to the subject area of another different output image when the moving subject is included in the predetermined output image; and
a 3D output image creation unit configured to create a 3D output image including the output image having a predetermined disparity from the predetermined output image out of a plurality of the output images and the corrected predetermined output image.

13. An image processing device comprising:
a strip image creation unit configured to create a plurality of consecutive output images where a particular area as an image capturing target is displayed during capture of images to be captured based on a plurality of captured images obtained through the image capturing using an image capturing unit while moving the image-capturing unit;
a panorama image creation unit configured to create a 3D panorama image including first and second panorama images having a disparity from each other by collectively synthesizing each of the first and second strip images obtained from a plurality of the captured images and displaying the same area on an image capturing space used as an image capturing target during capture of a plurality of images to be captured;
a detection unit configured to detect a moving subject having motion from the captured images based on motion estimation using the captured images; and
a correction unit configured to correct the first panorama image to remove the moving subject included in the first panorama image based on a result of detection of the moving subject by substituting a subject area included in the moving subject on the first panorama image with an image of an area corresponding to the subject area on the captured image when the moving subject is included in the first panorama image.
